(19) United States
(12) Patent Application Publication
(10) Pub. No.: US 2012/0213436 A1
(43) Pub. Date: Aug. 23, 2012

(54) Fast Image Enhancement and Three-Dimensional Depth Calculation

(75) Inventors: Gene A. Grindstaff, Decatur, AL (US); Sheila G. Whitaker, Gurley, AL (US)

(73) Assignee: HEXAGON TECHNOLOGY CENTER GMBH, Heerbrugg (CH)

(21) Appl. No.: 13/154,200

(22) Filed: Jun. 6, 2011

Related U.S. Application Data
(63) Continuation-in-part of application No. 13/030,534, filed on Feb. 18, 2011.

(51) Int. Cl. G06K 9/00

(52) U.S. Cl. 382/167

(57) ABSTRACT

Embodiments of the present invention relate to processing of digital image data that has been generated by imaging a physical object through a medium. For example, the medium may be, the atmosphere and the atmosphere may have some inherent property, such as haze, fog, or smoke. Additionally, the medium may be media other than the atmosphere, such as, water or blood. There may be one or more media that obstructs the physical object and the medium resides at least in front of the physical object between the physical object and an imaging sensor. The physical object may be one or more physical objects that are part of a scene in a field of view (e.g. view of a mountain range, forest, cars in a parking lot etc.). An estimated transmission vector of the medium is determined based upon digital input image data. Once the transmission vector is determined, effects due to scattering can be removed from the digital input image producing a digital output image that enhances the digital input image so that further detail may be perceived. Additionally, the estimated transmission vector may be used to determine depth data for each addressable location within the image. The depth information may be used to create a three-dimensional image from a two dimensional image.

### CROSS-REFERENCE TO RELATED APPLICATIONS

This application is a continuation-in-part of prior U.S. application Ser. No. 13/030,534, filed Feb. 18, 2011, the contents of which are incorporated herein by reference in their entirety.

### TECHNICAL FIELD

The present invention relates to image analysis, and more particularly to color image enhancement by removal of unwanted visual artifacts and generation of three-dimensional image data.

### BACKGROUND ART

Many color photography images, particularly those recorded outdoors using either an analog or digital sensing device, have haze or fog that obscures the objects that are being recorded. This problem also occurs in false-color images or images taken in non-atmospheric environments, such as those found in applications as diverse as infrared photography, X-ray photography, photomicroscopy, and underwater and astronomical photography. A method is needed that allows rapid removal of the haze from the color image. Near real-time performance is desired, but has not been achievable using any realistic image processing calculation techniques currently available. It is known that haze may be represented by the Koschmieder equation, however solutions of this equation require numerous calculations that are too slow for real-time enhancement of either still photograph or video sequences.

### SUMMARY OF CERTAIN EMBODIMENTS OF THE INVENTION

Embodiments of the present invention relate to processing of digital image data that has been generated by imaging a physical object through a medium. For example, the medium may be, the atmosphere and the atmosphere may have some inherent property, such as haze, fog, or smoke. Additionally, the medium may be media other than the atmosphere, such as, water or blood. There may be one or more media that obstructs the physical object and the medium resides at least in front of the physical object between the physical object and an imaging sensor. The physical object may be one or more physical objects that are part of a scene in a field of view (e.g. view of a mountain range, forest, cars in a parking lot etc.).

First, an estimated transmission vector of the medium is determined based upon digital input image data. Once the transmission vector is determined, effects due to scattering can be removed from the digital input image producing a digital output image that enhances the digital input image so that further detail may be perceived. For example, the effect of haze, smog, or smoke may be reduced such that the information representative of the physical object is enhanced with increased visibility. Additionally, the estimated transmission vector may be used to determine depth data for each addressable location within the image. The depth information may be used to create a three dimensional image from a two dimensional image.

In one embodiment computer-implemented method of generating depth data based on digital input image data is disclosed. In a first computer-implemented process, an estimated transmission vector for the medium is determined. In a second computer-implemented process, the depth data based on the estimated transmission vector is derived. Components of the estimated transmission vector are substantially equal to at least one normalized spectral channel value for the digital input image data. Additionally, each spectral channel value comprises contributions of at least one of attenuation in a first spectral band and scattering in a second spectral band. In additional embodiments, components of the estimated transmission vector vary with spectral characteristics of distinct spectral bands. In a further embodiment, the spectral bands are selected based upon a pre-determined criterion. The pre-determined criterion may be based upon spectral characteristics of the medium, spectral characteristics of the physical object, based upon distance among other criteria. In some embodiments the pre-determined criterion optimizes distance resolution.

The spectral bands may include one or more visible spectral bands, ultraviolet spectral bands, and infrared spectral bands. Additionally, the scattering of the light may be due to Mie-scattering, Raman-scattering, Rayleigh scattering or Compton scattering. Embodiments of the invention may further compensate the estimated transmission vector based upon a known spectral characteristic of the medium. The spectral bands may also be chosen based upon a known spectral characteristic of the medium. The estimated transmission vector may also be compensated based upon a known spectral characteristic of the physical object. The spectral bands may also be weighted, such that the weights form a filter.

The spectral band may correspond to one of blue, yellow, green and red color data from the digital input image data in some embodiments. The physical object may be imaged by a sensor due to natural illumination or due to tailored illumination. In certain embodiments, the tailored illumination may be due to a non-thermal emitter (e.g. black body) The spectral bands may be determined based upon spectral characteristics of the non-thermal emitter in order to reduce scattering.

The depth value may be determined by:

d(x,y)=−β*ln(t(x,y))

wherein d(x,y) is the depth value for a pixel at coordinates (x,y), β is a scatter factor, and t(x,y) is the estimated transmission vector.

A normalizing factor may be employed so that the estimated transmission vector components are valued between 0.0 and 1.0. The normalizing factor may be a value for scattered ambient light in the input image data. The estimated transmission vector is further calculated based upon the normalizing factor (e.g. the value for scattered ambient light in the input image data). In certain embodiments, the digital input image data comprises a plurality of color channels each having an intensity value associated with each position within the image. In one embodiment, the value for scattered ambient light is determined by finding the maximum of the minimum values for all of the color channels. In some embodiments, the scattered ambient light is a vector and the components of the vector may be used in determining the estimated transmission vector.

In embodiments of the invention, the spectral channel may be selected to maximize a range of values of the transmission vector in the field of view.

In still further embodiments, a computer-implemented method of generating output digital image data based on digital input image data is disclosed. The digital input image data represents a physical object in a field of view imaged through a medium. As before this method requires determining an estimated transmission vector for the medium. The estimated transmission vector may then be used in combination with the input digital image data to derive output digital image data. Components of the estimated transmission vector are substantially equal to at least one normalized spectral channel value for the digital input image data. Additionally, each spectral channel value comprises contributions of at least one of attenuation in a first spectral band and scattering in a second spectral band.

In order to determine the output digital image data the following equation is solved for J:

I(x,y)=J(x,y)*t(x,y)+A*(1−t(x,y))

where I is a color vector of the input image derived from the input image data, J is a color vector that represents light from objects in the input image, t is the estimated transmission vector, and A is a constant that represents ambient light scattered in the input image data. A may be a constant across all colors in an image or may vary with color, but is generally considered to be independent of position. The value of A may be considered the normalizing factor.

Any of the above referenced limitation may similarly be applied to the determination of the estimated transmission vector for determining the output digital image data. For example, the spectral channels may be selected based upon spectral characteristics of the medium or spectral characteristics of the physical objection.

Similarly, the above described methods for determining depth data or for determining the output digital image data may be implemented as computer program code that is stored on a non-transitory computer-readable medium for use with a computer.

The invention may also be embodied in an image processing system that includes a plurality of modules. A module may be computer software that operates on a processor wherein the processor is considered to be part of the module, the modules may also be implemented in computer hardware, such as an ASIC (application specific integrated circuit, or the module may be a combination of an integrated circuit and supporting computer code.

The image processing system in certain embodiments may include an input module that receives digital input image data for a physical object imaged through a medium. Additionally, the image processing system includes an atmospheric light calculation module that receives the digital input image data from the input module and calculates atmospheric light information Further the system includes a transmission vector estimation module that receives the digital input image data from the input module, and estimates a transmission vector for the medium based on a spectral band of the digital input image data and the atmospheric light information. Finally, the system includes an enhanced image module that receives digital input image data and the transmission vector and generates output image data. The system may further include

an illumination source for illuminating the physical object through the medium and a sensor for receiving energy representative of the physical object through the medium and converting the energy into digital input image data.

Embodiments of the image processing system may further include an output module that receives the output image data and outputs the output image data to at least one of a digital storage device and a display.

Embodiments of the image processing system may be adapted to determine depth data. In such embodiments, a depth calculation module receives digital input image data and the transmission vector and generates a depth map. The depth map may be used to create three-dimensional image data. In such a system, a three-dimensional image generation module is included. This three-dimensional image generation module receives the digital input image data and the depth map and generates three-dimensional output image data using the digital input image data and the depth map. The three-dimensional output image may be provided to an output module and the output module may provide the three-dimensional output image data for display on a display device or for storage to memory.

### BRIEF DESCRIPTION OF THE DRAWINGS

The foregoing features of embodiments will be more readily understood by reference to the following detailed description, taken with reference to the accompanying drawings, in which:

FIG. 1 is a flow chart of a process for enhancing image data in accordance with embodiments of the present invention.

FIGS. 2 and 2A are flow charts of processes for generating image data using an estimated transmission vector in accordance with embodiments of the present invention.

FIGS. 2B and 2C are flow charts of alternative embodiments to FIGS. 2 and 2A;

FIGS. 3 and 3A are flow charts of processes for determining a value for use in estimating the transmission vector used in FIGS. 2 and 2A.

FIG. 4 is a block diagram of an image processing system in accordance with an embodiment of the present invention.

FIGS. 5A-5L are photographic images, each pair of images (FIGS. 5A and 5B, 5C and 5D, 5E and 5F, 5G and 5H, 5I and 5J, and 5K and 5L) show an original hazy image and an enhanced, haze-removed image.

FIGS. 6A-6L are photographic images, each pair of images (FIGS. 6A and 6B, 6C and 6D, 6E and 6F, 6G and 6H, 6I and 6J, and 6K and 6L) show an original image and an image representing depth data.

### DETAILED DESCRIPTION OF SPECIFIC EMBODIMENTS

Various embodiments of the present invention permit removal of attenuation effects and calculation of three-dimensional distance information from images and video, without perceptible delay (i.e., in “real time”). For raster images and video based on visible atmospheric light, such as images and videos generated by a digital camera, the methods and systems disclosed herein are able to remove the appearance of haze, smoke, smog, non-opaque clouds, and other atmospheric scattering phenomena, and restore the appearance of visual elements partially obscured by these phenomena. These techniques are also applicable to images using sensor data pertaining to other portions of the electromagnetic spectrum. At the same time, these methods and systems permit calculation of the “depth” of each pixel; that is, the distance from the imaging device to a physical object that corresponds to the pixel. Various embodiments of the invention also may be used with sensors or detectors that detect other wave-like phenomena, such as sound waves or other pressure waves, and other phenomena that are capable of being measured and represented as an image or video. An excellent background discussion of the relevant optical principles, including scattering and absorption, on which various embodiments of the invention are based may be found in Applied Optics (John Wiley & Sons, 1980). Portions relevant to the discussion herein include chapter 12 regarding atmospheric imaging and its appendix 12.1 that covers Rayleigh scattering and Mie scattering. In other, non-atmospheric media, such as liquids or solids, inelastic scattering processes, such as Raman scattering in the infrared, or Compton scattering in the x-ray portion of the electromagnetic spectrum, may also figure in the techniques described herein.

### DEFINITIONS

As used in this description and the accompanying claims, the following terms shall have the meanings indicated, unless the context otherwise requires:

The term “sensor,” as used herein, will refer to the entirety of a sensing apparatus, and may, in turn, constitute an array of subsensors having particular spectral, or spatial, specificity. Each subsensor is sensitive to radiation within a field of view associated with the subsensor. The sensed radiation is typically, radiant energy such as electromagnetic radiation, and, more particularly, light radiation, however other radiated modalities such as sound (longitudinal waves in a medium) or massive particles (such as neutrons) are also encompassed within the scope of the present invention.

The term “image” refers to any representation, in one or more dimensions, whether in tangible, or otherwise perceptible, form, or otherwise, whereby a value of some characteristic (such as light intensity, for example, or light intensity within a specified spectral band, for another example) is associated with each of a plurality of locations corresponding to dimensional coordinates in physical space, though not necessarily mapped one-to-one thereonto. Similarly, “imaging” refers to the rendering of a stated physical characteristic in terms of one or more images.

A “digital image” is a function of one or more variables whose values may be stored in a computing system as digital data. A “tangible image” is a digital image that is perceptible by a person, whether by virtue of projection onto a display device, or otherwise. If a tangible image is perceptible visually, the values of its function may be encoded as pixel data having several color components according to a color model, such as RGB, YUV, CMYK, or other color model known in the art. Similarly, where false color image includes the ultraviolet and infrared, a UVBRI color system may be used, for example. Pixel data may also be encoded according to a black-and-white or grayscale model.

As a concrete example, a two-dimensional tangible image may associate particular RGB values with (x, y) coordinates of a collection of pixels. Pixel values may be arranged in rows and columns that represent their “x” and “y” coordinates. The intensity value of each color is represented by a number. The intensity value may be in the range 0.0 to 1.0 (which is bit depth independent), or it may be stored as an integer value depending on a number of bits used to encode it. For example an eight bit integer value may be between 0 and 255, a ten bit value between 0 and 1023, and a 12 bit value between 0 and 4095.

A sensor employed in deriving an image may be referred to herein, and in any appended claims, as an “imaging sensor.”

Signal values corresponding to measurements of signal intensity performed by a sensor and its subsensors are referred to herein, collectively, as “input image data,” and, when digitized, as “digital input image data.”

The “spectral range” of a sensor is the collection of frequencies that may be measured by the sensor. A “spectral band” is a contiguous range of frequencies within a spectral range. The spectral range of a sensor may include several (possibly overlapping) spectral bands, frequencies formed from interference of the spectral bands, harmonics of frequencies in the contributing spectral bands, and so on.

A “spectral channel” refers to a defined spectral band, or weighted combination of spectral bands.

A “spectral channel value” refers to a measured intensity, in whatever units are used to represent intensity, collected over one or more spectral bands for a particular application, Thus, data measured in the blue band, for example, constitute a spectral channel value. A weighted admixture of intensity measurements in the blue and red bands may serve, in other applications, as a spectral channel value.

A spectral channel value may be referred to as “normalized” when it is placed on a scale of real values between 0.0 and 1.0.

The term “source intensity” refers to energy flux of light radiated by a source imaged within a pixel, which is to say, the spectral irradiance of the source as illuminated within a scene integrated over the area within the field of view of a pixel and integrated over a specified spectral band or spectral channel.

A “transmission coefficient” is a value between 0.0 and 1.0 that represents the ratio between a detected intensity and a source intensity of energy in a spectral band. A “transmission vector” is a vector composed of transmission coefficients, where each component of the transmission vector represents the transmission coefficient associated with a specified spectral band. As described in more detail below, the source intensity, across a given spectral range, of an energy source that is obscured by attenuation effects of an interposed medium may be calculated using, among other things, the detected intensity in each of a number of spectral bands and an estimated transmission vector.

A “color channel” of a pixel of digital image data refers to the value of one of the color components in the pixel, and a “color channel value” refers to the value in intensity units of the signal sensed in that channel. For example, an RGB-type pixel will have a red color channel value, a green color channel value, and a blue color channel value.

A “color channel” of a digital image refers to the subset of the image data relating to a particular color, or, more generally, to a particular spectral band. For example, in a digital image comprising RGB-type pixels, the blue color channel of the image refers to the set of blue color channel values for each of the pixels in the image. Collectively, digital image data by spectral band may be referred to herein as “color image data.”

“Haze” in a photographic image of an object refers to anything between the object and the camera that diffuses the source energy (e.g. the visible light) reflected by or transmitted through the object before detection by the camera. Haze includes compositions such as air, dust, fog, and smoke. Haze causes issues in the area of terrestrial photography in particular, where the penetration of light through large amounts of dense atmosphere may be necessary to image distant subjects. The presence of haze results in the visual effect of a loss of contrast in the subject, due to the effect of light scattering through the haze particles. The brightness of the scattered light tends to dominate the intensity of the image, leading to the reduction of contrast.

In accordance with various embodiments of the invention, scattering effects caused by a medium are removed from a digital image by first determining an estimated transmission vector for each pixel in the image, then calculating a corresponding pixel in a digital output image based in part upon the estimated transmission vector. Once the transmission vector is known for a pixel in the input image, a distance from the sensor to the object imaged by that pixel (hereinafter the “pixel depth” or “object depth”) may be determined using a simple formula, thereby creating three-dimensional data based on the two-dimensional input image data.

These processes advantageously may be performed in real-time because the disclosed techniques are based upon particularly efficient methods of estimating unknown variables, including the amount of ambient illumination (e.g., air light) and the transmission vector. In particular, one may apply these processes to a sequence of digital images, thereby reducing or removing the appearance of haze and other scattering effects, recovering the true color of an object imaged through haze, and calculating the depth of each imaged pixel, all without perceptible delay.

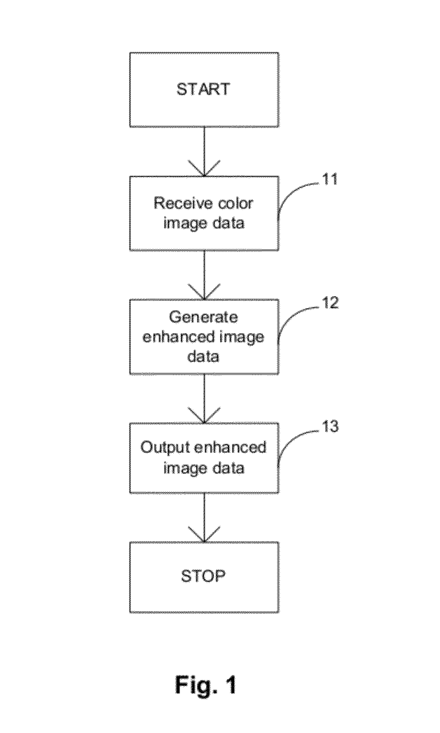

A method for enhancing a photographic image in accordance with various embodiments of the present invention is now described with reference to FIG. 1. The photographic image may be stored in an image processing system as digital data originating from a digital source, where the digital data are encoded as color information (e.g., RGB, YUV, etc.). An image processing system receives input image data in process 11. In some embodiments, the input image data may be video data comprising a series of still images. The image data may be in any digital image form known in the art, including, but not limited to, bitmap, GIF, TIFF, JPEG, MPEG, AVI, Quicktime and PNG formats. The digital data may also be generated from non-digital data. For example, a film negative or a printed photograph may be converted into digital format for processing. Alternatively, a digital photographic image may be captured directly by digital camera equipment.

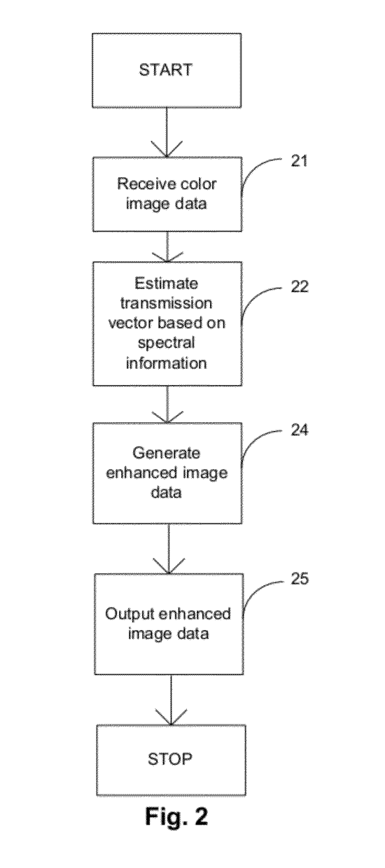

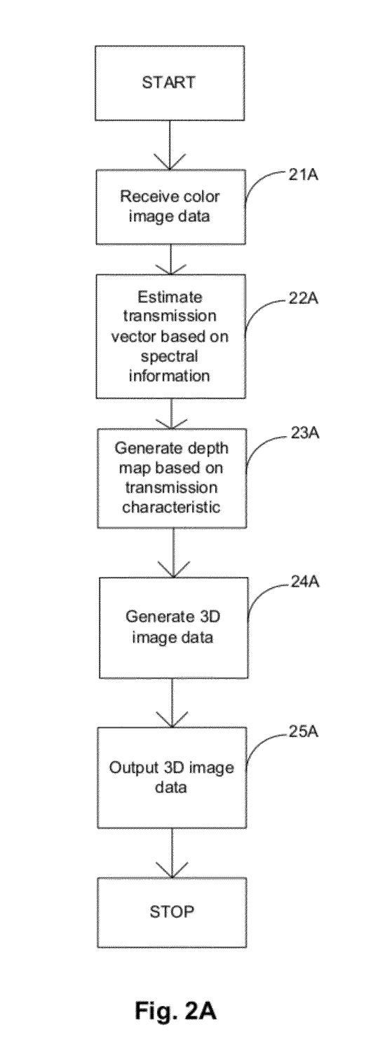

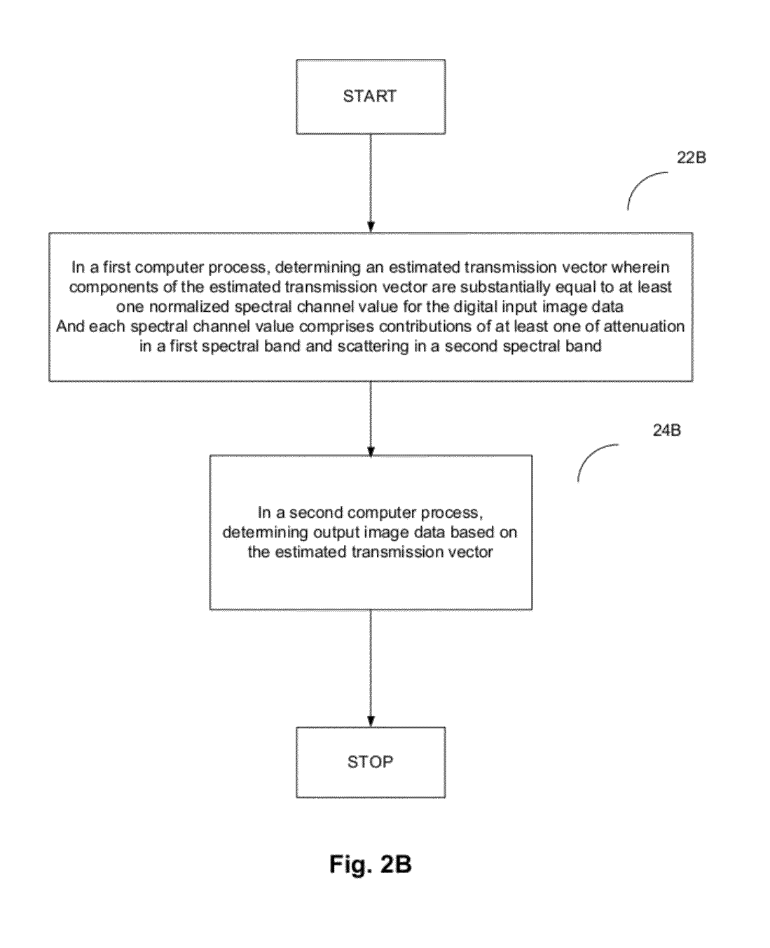

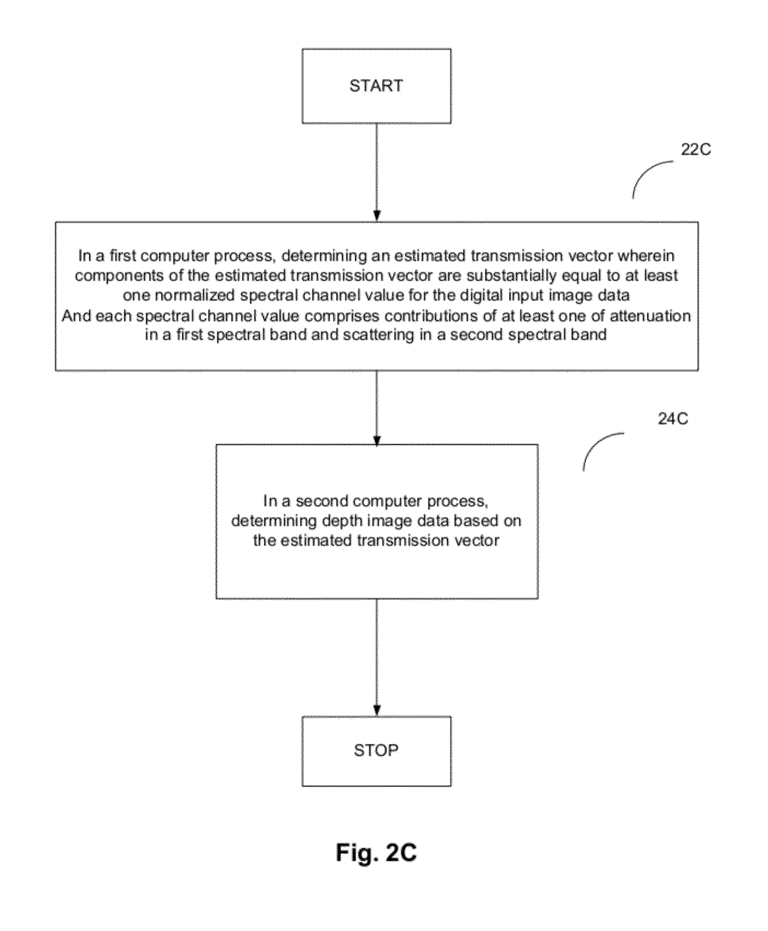

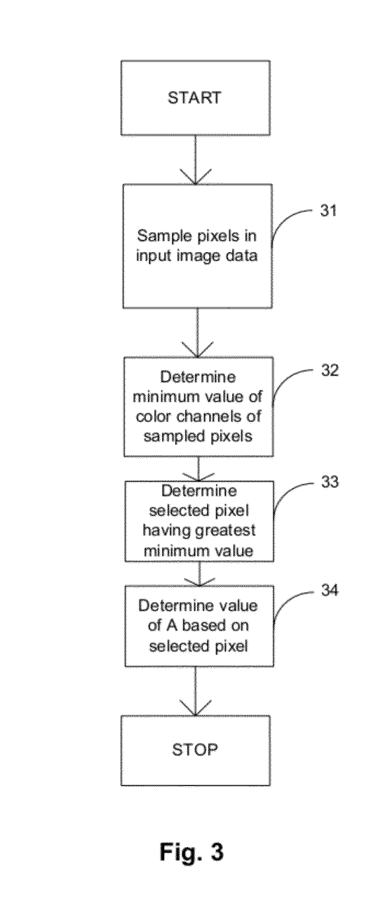

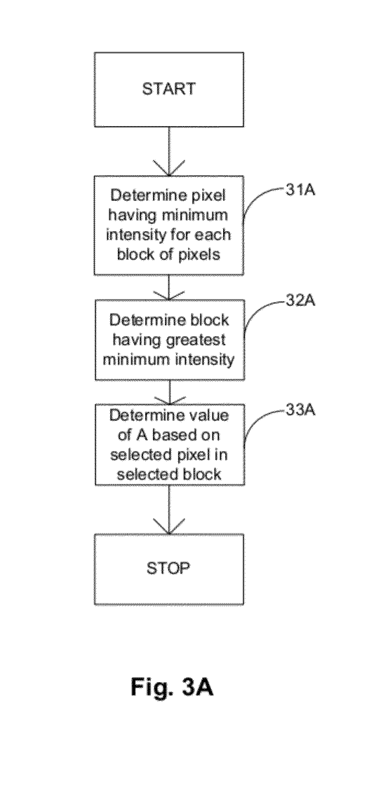

The image processing system then processes the input image data to generate enhanced image data in process 12. According to some embodiments, the enhanced image data has a reduced amount of scattering (e.g., atmospheric haze) relative to the input image data. Reduction of haze in an image enhances information that is present within the image, but that is not readily visible to the human eye in the hazy image. Alternatively, or in addition, the enhanced image data may include depth information. For example, two-dimensional (2D) input image data may be converted into three-dimensional (3D) image data. Particular methods by which embodiments of the invention create these enhanced image data are described in detail below in connection with FIGS. 2, 2A, 3, and 3A.

The image processing system then outputs the enhanced image data 13. The data may be output to storage in a digital storage medium. Alternatively, or in addition, the data may be output to a display as a tangible image where it may be viewed by an observer.

Techniques for removing scattering effects in images in accordance with various embodiments of the present invention are now described in more detail. According to the well-known Koschmieder equation, image data may be modeled as follows:

I(x,y)=J(x,y)*t(x,y)+A*(1−t(x,y)),

where “I” is a value of the recorded image at position (x, y), “J” is a value that represents light from physical objects in the image, “A” represents the light scattered from the atmosphere or fog (i.e., “haze”), and “t” is a transmission vector of the scene that represents attenuation effects. “A” is typically considered to be position-independent over some specified portion of the overall field of view Physically, J*t may be viewed as energy intensity flux from the physical objects, as attenuated by an interposed medium, and A*(1−t) represents the energy scattered by the medium. In atmospheric visible photography in particular, the color detected by a camera sensor is a combination of (attenuated) visible light from the physical objects in the scene, and thermal light from the Sun scattered by atmospheric haze.

The values of “I” are the input values of the color image data, where I(x, y) refers to the pixel at location (x, y) in the image. Each pixel has a plurality of color channel values, usually three, namely red, green, and blue (RGB) although other color systems may be employed. The values of “J” are theoretical values of the color values of the pixels without the addition of any haze. Some of the methods that are described below determine how to modify the known values of “I” to generate values of “J” that will make up a haze-reduced image. Values for “J” can be derived if values can be found for both A and t(x, y), by solving the Koschmieder equation using algebraic manipulation. Unlike I, J and t, which vary according to coordinates (x, y), A is a single value that is used for the entire image. Conventionally, A can have any value ranging between 0.0 and 1.0. For typical bright daylight images, A will be significantly closer to 1.0 than to 0.0, including values mostly between about 0.8 and 0.99. For darker images, however, A may be significantly lower, including values below 0.7. Procedures for estimation of A and t(x, y) in real-time in accordance with embodiments of the present invention are described in detail below.

A process for reducing the appearance of scattering in image data is now described with reference to FIG. 2. An image processing system first receives in process 21 color image data, as was described above with reference to 11 in FIG. 1. The color image data may comprise several color channels. For example, in one useful embodiment, the image data include a red color channel, a green color channel, and a blue color channel. Each color channel may represent image data detected by a sensor tuned (by means of one or more filters, or by inherent sensitivity of the sensing material) to a particular contiguous spectral band. Alternatively, a color channel may represent a weighted average of data from several such sensors. Knowledge of the spectral range of the sensor or sensors that detected the image is useful in certain embodiments described below. However, such knowledge is not necessary to implement the embodiment of FIG. 2; only the image data are required. Note that, while the colors represented by the color channels may lie within the visible spectrum so that a person can perceive the tangible image, the data represented by each color channel may be derived from sensor data that represents detected energy that lies outside the visible spectrum.

Having received the image data, the image processing system then estimates in process 22 a transmission vector for the image data based on spectral information for one contiguous spectral band of the digital image input data. The transmission vector describes the attenuation of radiant energy as it travels through a medium, including its absorption and scattering properties. Thus, in one embodiment, the transmission vector describes the transmission through the air of light that was present when a photographic image was taken. According to one embodiment of the present invention, the transmission vector is estimated based on a single color channel in the image data, without the need to consider any other color channels.

For example, the blue channel is used in a typical embodiment having an RGB photographic image of objects through the Earth's atmosphere. In embodiments in which color systems other than RGB are used, blue channel values (or other values appropriately serving as the basis of a transmission coefficient estimate) may be derived from the color channels used in the color model. According to these embodiments, the transmission vector is estimated based on image data from a weighted combination of several color bands that represent a contiguous spectral band (in this case, a blue spectral band).

Modeling the transmission of light through the atmosphere also may include calculating a value of A, which is a constant that represents the light scattered from the atmosphere or fog in the image data (i.e., haze), as is described below with reference to FIGS. 3 and 3A. According to some particularly useful embodiments of the present invention, the transmission vector of a scene is then estimated as being equal to the inverse of the blue color channel for the images, normalized by the factor “A”:

t(x,y)=1−(I_{blue}(x,y)/A),

Where I_{blue}(x,y) is the blue channel of the pixel at location (x,y). In some embodiments, a root-mean-square value of A derived from several pixels is used to estimate t(x, y) in the above equation, but a value of A derived from a single pixel is used to represent attenuation due to the medium when solving the Koschmieder equation. These methods are explained in more detail below in connection with FIGS. 3 and 3A.

Experimentation has shown this estimate to be highly accurate for images of physical objects lying within a scene as viewed through the Earth's atmosphere, resulting in fast and efficient haze-removal and depth mapping. The blue channel's effectiveness in modeling the transmission can be related to the physics of Rayleigh scattering of the Sun's light in the atmosphere. Use of this estimate of the transmission in the Koschmieder equation described above allows for rapid contrast enhancement of the image data without loss of detail.

Once the transmission vector has been estimated, the image processing system can generate enhanced image data 24. The enhanced image data (which may also be referred to, herein, as “output image data”) are generated by solving for J in the Koschmieder equation, described above. For example, J may be calculated as shown in the following pseudocode:

```
for y = 0 to height−1
  for x = 0 to width−1
  outpixel(x,y).red=A+(inpixel(x,y).red−A)/255−inpixel(x,y).blue/255)
  outpixel(x,y).green=A+(inpixel(x,y).green−A)/255−inpixel(x,y).blue/255)
  outpixel(x,y).blue=A+(inpixel(x,y).blue − A)/255−inpixel(x,y).blue/255)
```

In this example, the value 255 represents the maximum brightness value of a color channel, and the blue color channel was used to estimate the transmission vector.

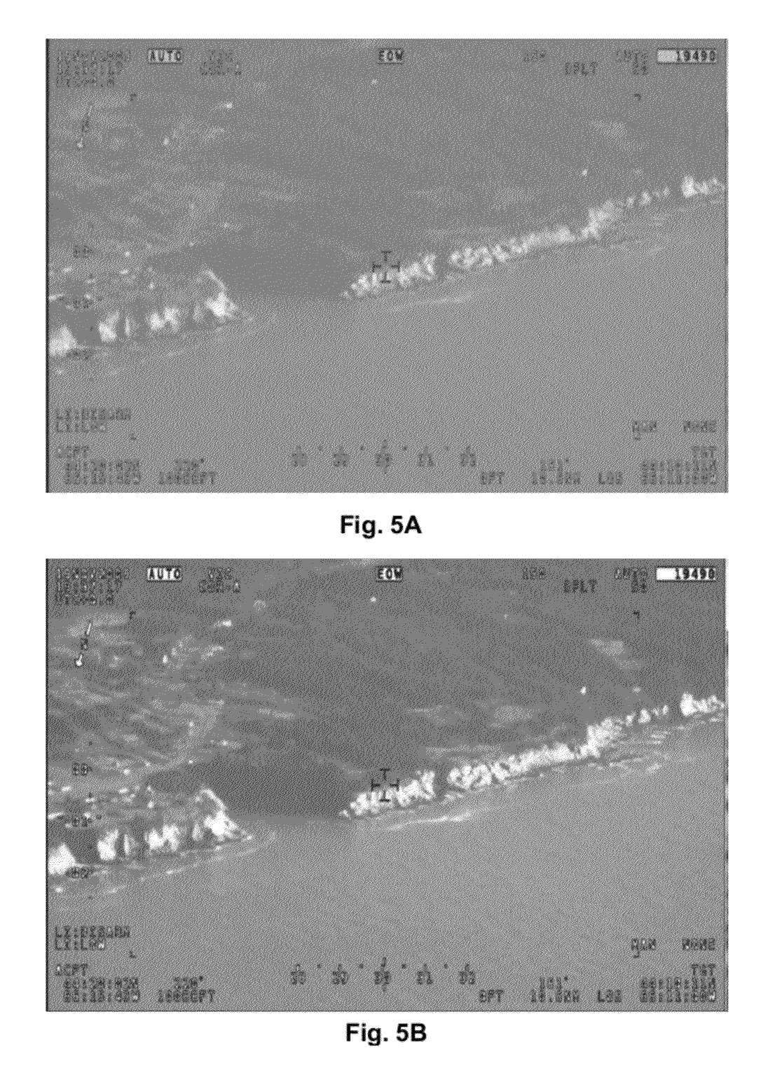

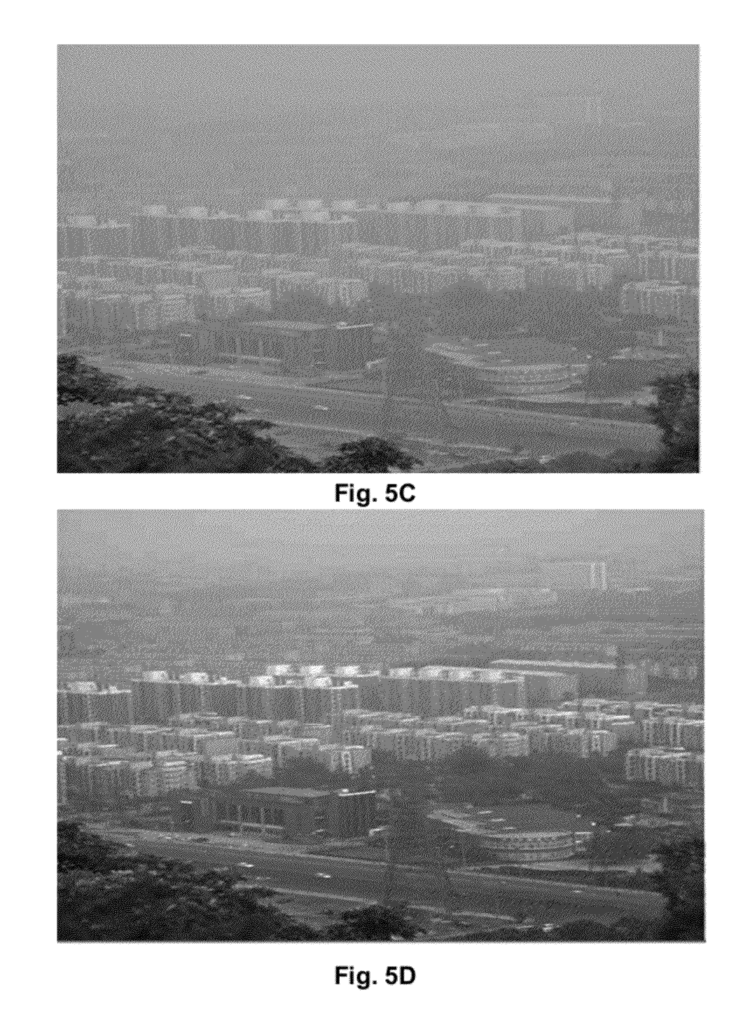

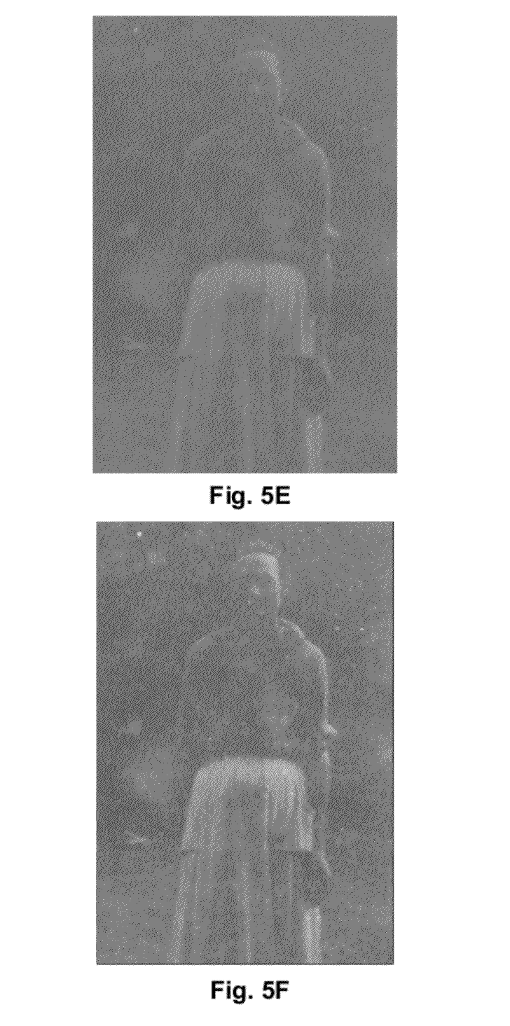

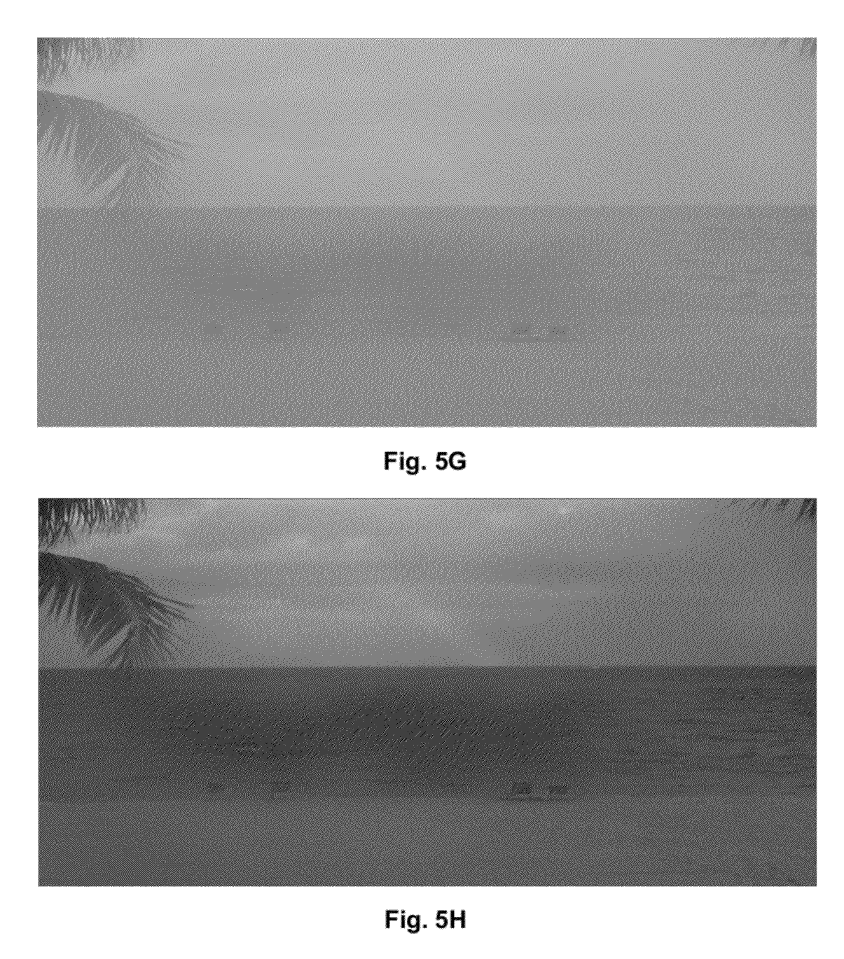

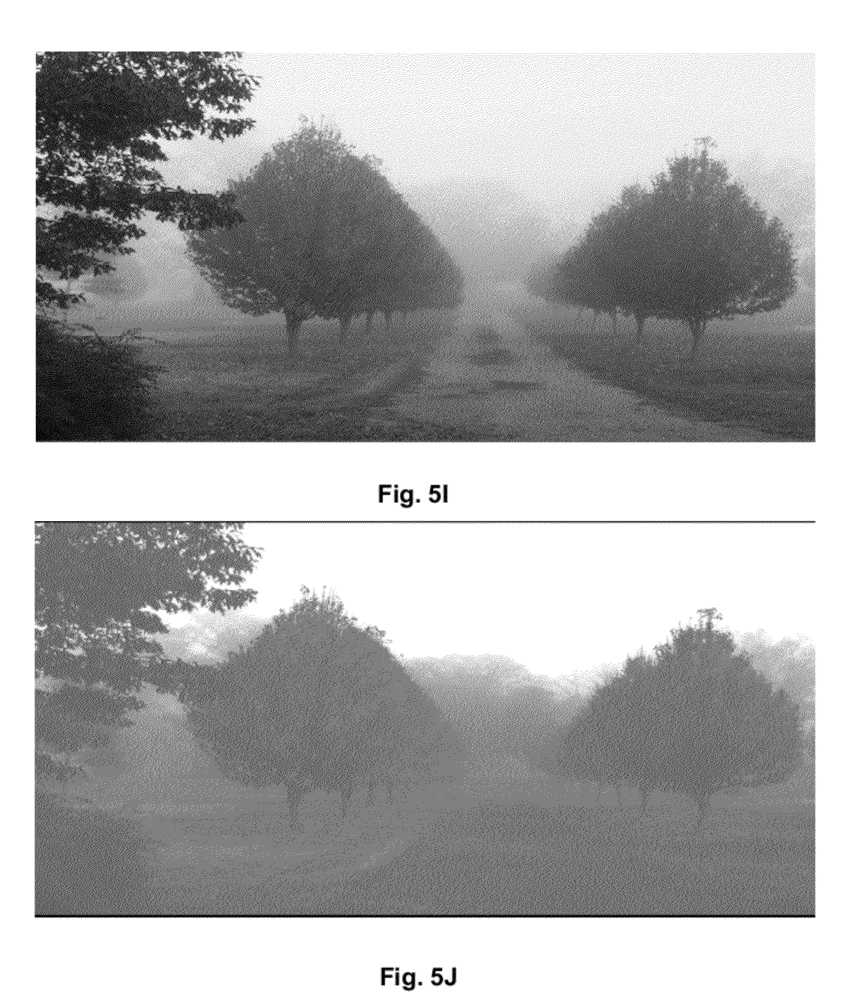

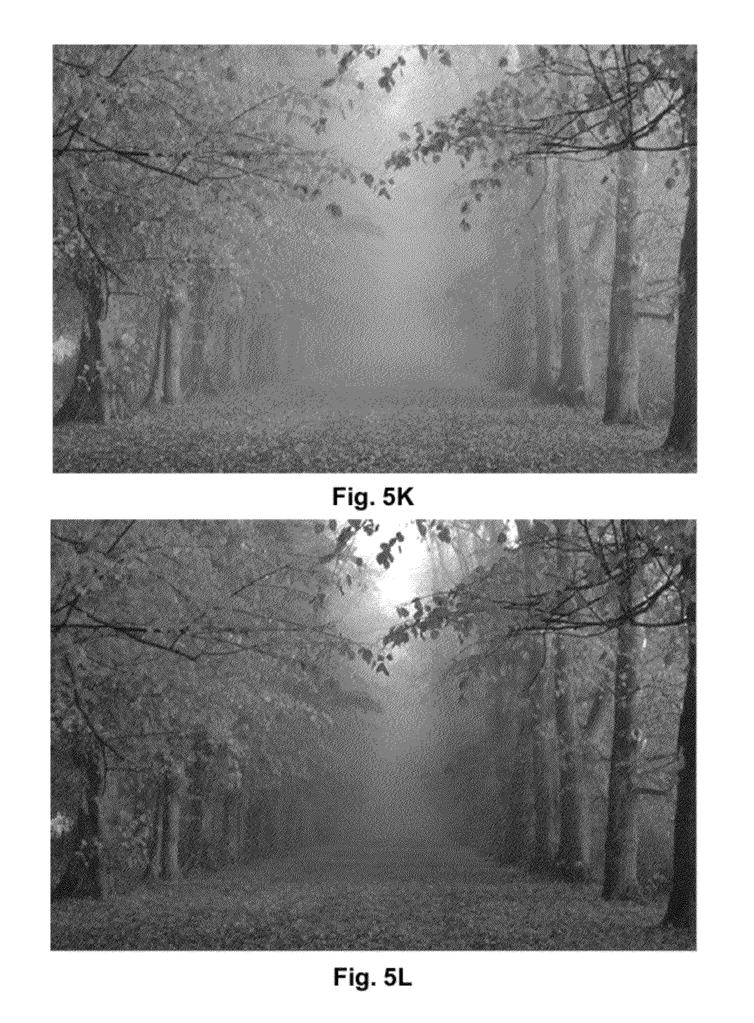

In process 25, the enhanced image data are output by an output module of the image processing system. The data may be output to volatile memory, non-volatile storage, a display, or other device. Exemplary before-and-after images are provided in FIGS. 5A-5L, showing an original image on the top, and showing an enhanced image on the bottom.

It will be appreciated that other light-attenuating phenomena may dominate in different spectral bands based on the medium and the size of the relevant scattering particles, and that images of these phenomena may be quickly adjusted using colors other than blue. For example, red is particularly useful for blood photography, yellow is an effective color to filter smoke from an image of a forest fire, and green is useful for underwater photography. The selection of spectral channel for purposes of estimating the transmission vector may be based upon a pre-determined criterion, such as spectral characteristics of the imaged physical object or of the intervening medium. More particularly, in the context of depth maps, discussed below, the pre-determined criterion may advantageously be chosen to optimize distance resolution. A person having ordinary skill in the art may recognize that other colors are more advantageous to use with the disclosed fast estimation technique in other applications.

More generally, false-color images of radiation outside the visible spectrum may be adjusted using the same techniques, using color image data that comprise a tangible image. For instance, an X-ray image of the human body may be created using an X-ray emitter and sensor, and mapped onto visible colors for use in a tangible image. In this example, the human body acts as the attenuating medium. Scattering due to the human body of radiation at various frequencies in the emission spectrum may appear as “haze” in a tangible image. The color channels of the colors in the tangible image may be used, as described above, to remove these scattering effects, thereby resulting in a sharper digital output image.

Thus, estimating the transmission vector may be based on known scattering properties of the medium. In particular, the composition of the medium and the incident wavelength(s) of energy in various applications may require an estimation based on any of Rayleigh scattering or Mie scattering, and, in cases of infrared or X-ray imaging, Raman scattering or Compton scattering, for example. In these cases, colors other than blue may be used. Thus, as noted above, the transmission vector may be based on a yellow spectral band instead of a blue spectral band, to eliminate the appearance of smoke. As yellow is not a color channel in RGB image data, the yellow spectral band is derived as a weighted combination of the red, green, and blue values in an RGB image.

In some embodiments, estimating the transmission vector includes an initial estimation followed by compensating at least one component based upon a known spectral characteristic of the medium, such as absorption. The atmosphere is known to absorb incident radiation at frequencies characteristic of its constituent molecules; for example, ozone absorbs ultraviolet radiation from the Sun. Thus, in a false-color UV image for example, at least one component of the transmission vector may be compensated based on this known absorption. Indeed, the spectral band used to estimate the transmission vector may be chosen based upon knowledge of the spectral characteristics of the medium.

Similarly, at least one component of the estimated transmission vector can be estimated, compensated or adjusted based upon a known spectral characteristic of the physical object being imaged. For example, consider a tangible image, taken through the atmosphere, of a roof that appears pink. If the roof is known to be a particular shade of red, then the attenuation of the pixels that comprise the image of the roof (and thus the overall transmission vector for those pixels) may be precisely and quickly measured. This principle easily may be adapted to the broader situation in which more spectral information is known about the physical object than its visible appearance. Similarly to the embodiments described above, the spectral band used to estimate the transmission vector may be chosen based upon knowledge of the spectral characteristics of the physical object.

In further embodiments that extend these concepts, multiple spectral bands may be used to estimate the transmission vector. For example, one spectral band may be chosen to determine attenuation due to absorption (based e.g. on a knowledge of the composition of the medium), while a second spectral band may be chosen to determine scattering. By combining the above techniques as applied to each spectral band, one may obtain precise information about the transmission vector. Such techniques may be used, for example, to measure a gemstone's cut, clarity, or color against established standards. Indeed, based on the amount of scatter, as described below, the depth of the pixels comprising the gemstone may be determined, thereby determining a volume (and hence carat weight) for the stone. Such techniques may also be used to detect automobile brake lights through fog, by using a blue color channel to remove the fog and a red color channel to identify the brake lights. In another embodiment, sharper images may be obtained in non-atmospheric environments. Thus, a green color channel may be used to remove haze underwater, and a blue or red color channel may be used to obtain color or other information about distant objects.

The above techniques are especially effective in situations in which the lighting of a scene and the composition of the medium may be controlled by the individual controlling the imaging sensors. For instance, one may irradiate a scene with light having a particular frequency that is known to strongly (or weakly) scatter in order to enhance (or diminish) the effects of scattering in an image taken of the scene. By doing so, one may increase useful spectral qualities of the image advantageously, thereby allowing the above techniques to provide more accurate information about the scene. The light source may be thermal, or non-thermal, and may be tailored to the particular medium or physical object being imaged. Further, the medium itself may be altered, for example by the introduction of aerosols that have certain absorption spectra and desired scattering properties.

Derivation of values for t(x, y) is also useful because t(x, y) can be used to generate a depth map for an image describing the depth of field to each pixel in the image. This depth map can then be used for a number of practical applications, including generating a 3D image from a 2D image, as shown in FIG. 2A. While the prior art includes techniques for combining a plurality of 2D images to derive a 3D image, it has not been practical to quickly and accurately generate a 3D image from a single 2D image. Embodiments of the present invention, however, can calculate t(x,y) from a single image, which allows the depth, d(x,y), of a pixel to be determined according to the equation:

d(x,y)=−β*ln(t(x,y)),

where β is a scatter factor. In some applications, the scatter factor may be predetermined based on knowledge of the general nature of the images to be processed. In other applications, a separate ranging system such as a LIDAR system is used to determine a known depth for a particular pixel, and the scatter factor for the entire image is calculated based on the known depth of this pixel. Because the scatter factor is a constant for a given scene, knowledge of the depth of a single pixel and the transmission value at that pixel allows the scatter factor to be calculated by algebraic manipulation. In applications of, for example, geospatial images from aerial photography (such as from an unmanned aerial vehicle, satellite) the depth to the center pixel may be known, allowing the scatter factor to be calculated quickly for each image.

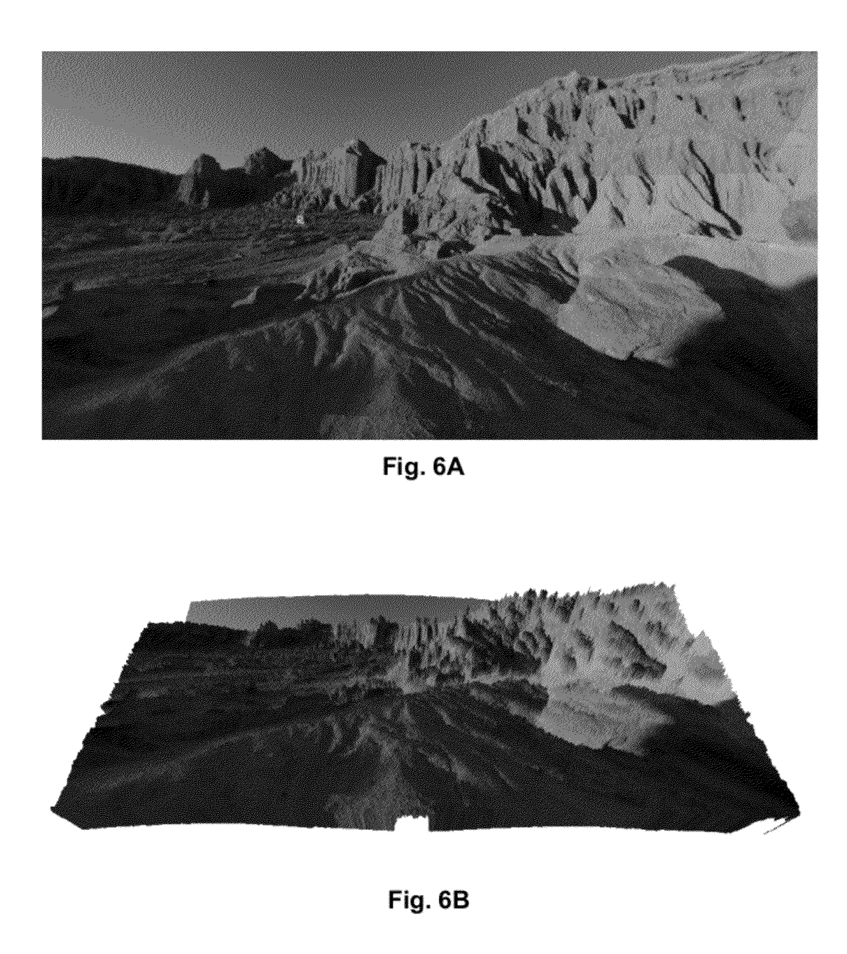

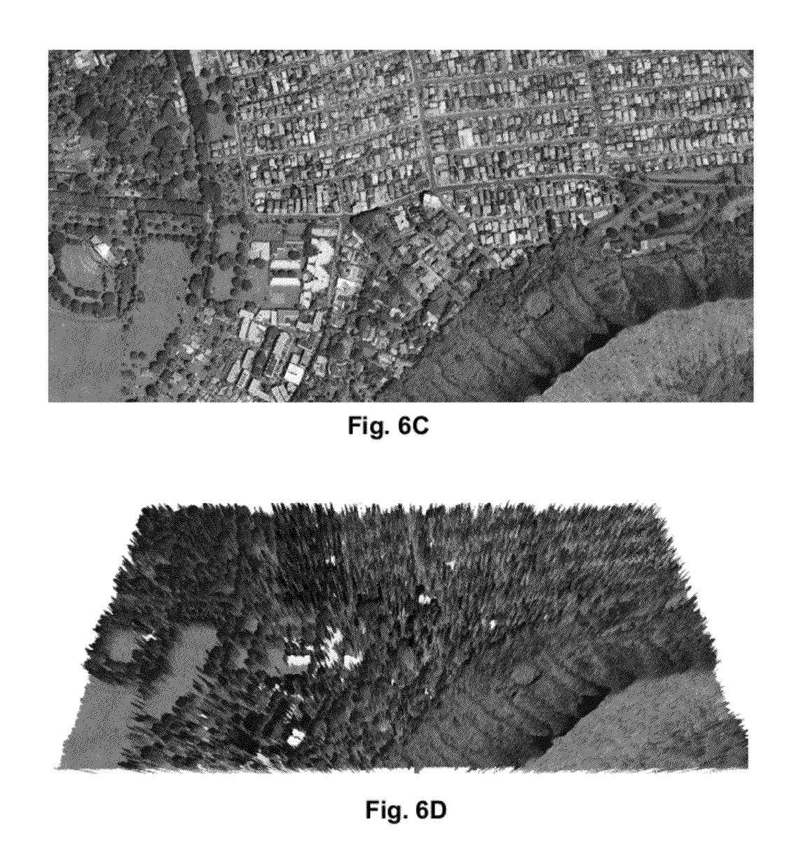

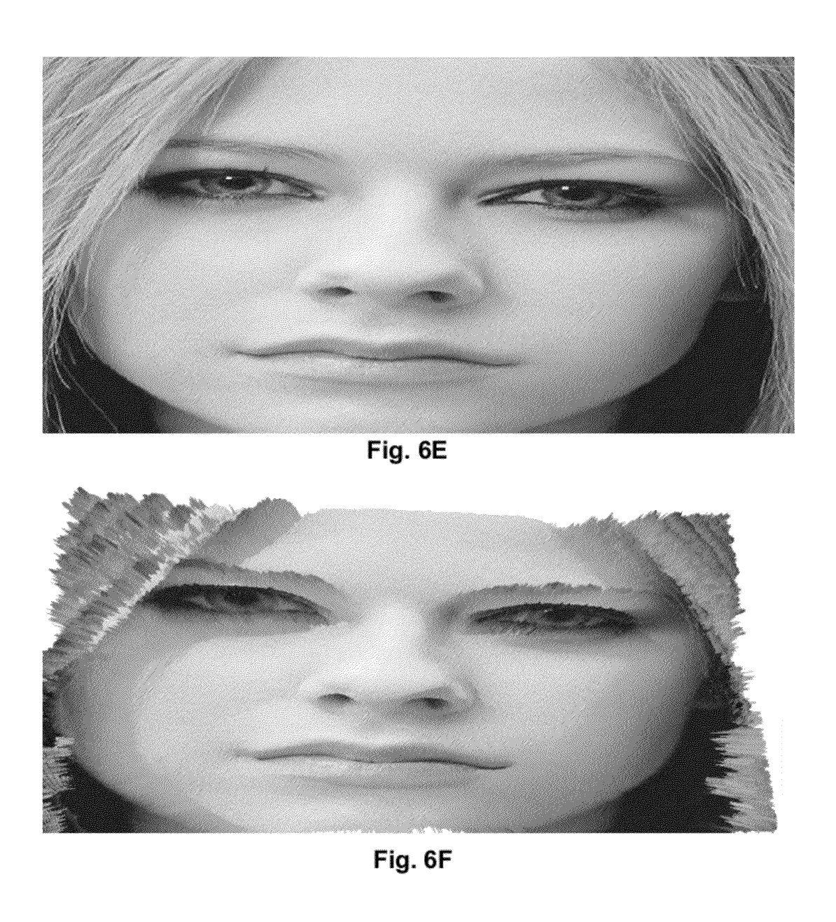

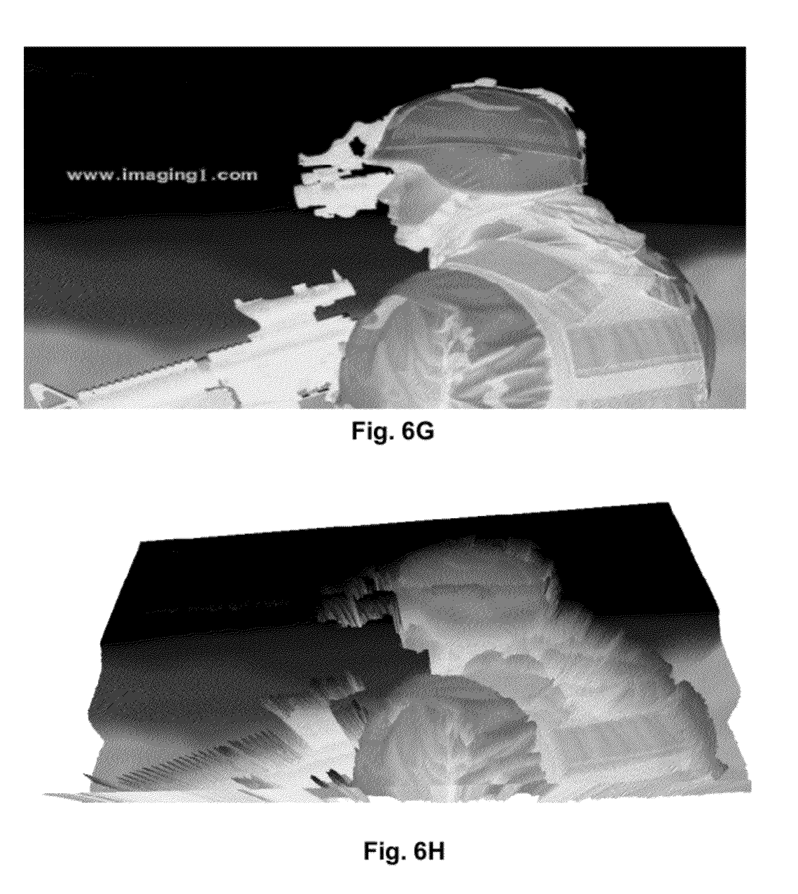

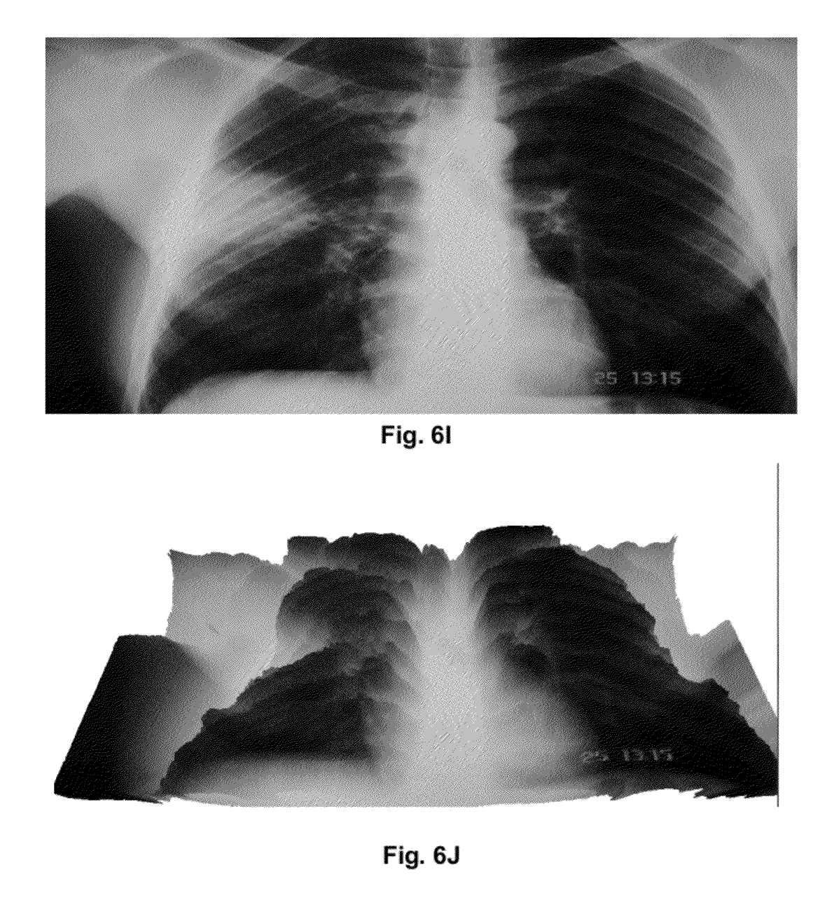

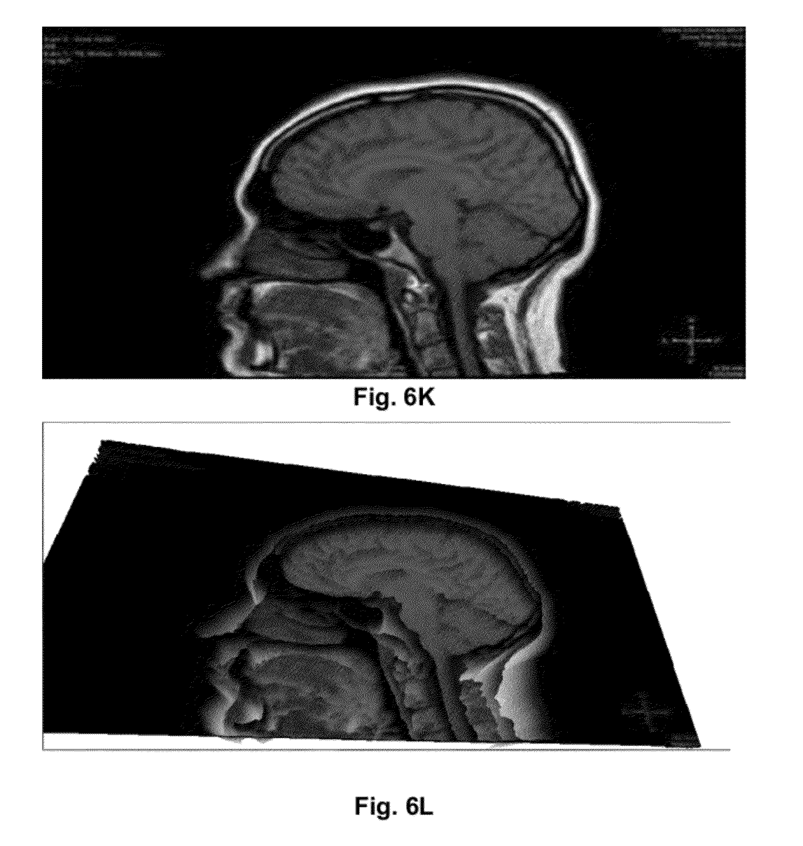

A method for generating 3D image data based on this technique, similar to the process of FIG. 2, is shown in FIG. 2A. Receiving the image data in process 21A and estimating the transmission vector in process 22A are performed as described above. In this method, however, the image processing system generates a depth map based on the transmission vector in process 23A. The depth map is then used to generate 3D image data in process 24A. The 3D image data is then output in process 25A. Exemplary before-and-after images are provided in FIGS. 6A-6L, showing an original image on the top, and showing an image representing the calculated depth information on the bottom.

The depth map for generating 3D image data is calculated by solving for d in the equation:

d(x,y)=−β*ln(t(x,y))

as described above. For example, d(x,y) may be calculated as shown in the following pseudocode:

```
for x = 0 to width−1
  for y = 0 to height−1
  d(x,y) = −beta * ln(t(x,y))
```

Depth maps generated by embodiments of the present invention have numerous practical uses. Grouped by broad category, these uses include, among others: analysis of still images; analysis of video having a stationary sensor; analysis of video having a moving sensor; real-time conversion of two-dimensional images and video into three-dimensional images and data; multi-band and multi-effect passive metrology; and creation of three-dimensional (stereoscopic) television displays realized with a two-dimensional array of pixels. Any of these uses may be improved using automatic algorithm or sensor adjustment. Some of the wide variety of practical uses are now enumerated.

There are many contemplated applications of this technique for creating real-time depth information from still images. Terrain maps may be generated from ground or aerial photography by creating depth maps to determine the relative elevations of points in the terrain, as shown, for example, in FIGS. 6A through 6D. Doctored photographs can be detected quickly and easily by analyzing a depth map for unexpected inconsistencies. For example, if two photographs have been combined to create what appears to be a single city skyline, this combination becomes apparent when looking at the depth map of the image, because the images that were combined are very likely to have been taken at differing distances from the scene. The depth map will have an abrupt change in the depth that is not consistent with the surrounding image's depth. Similarly, pictures containing steganographic information can be detected by analyzing a depth map to find areas of anomalies. Images with steganographic data may have very abrupt changes in pixel depth where the encoding has been altered, even if these changes are not visible to the human eye. Thus, these techniques are applicable in the field of forensic analysis and authentication of imagery. Additional applications include edge detection of imaged objects (by locating curvilinear discontinuities in depth), and shadow detection and elimination.

Static image analysis using the techniques described herein allows one to recognize structures within other structures, based on differences in spectral response, scattering and attenuation behavior, and texture. For instance, two-dimensional medical images such as X-rays and MRIs may be given a third dimension, as shown in FIGS. 6I through 6L, allowing doctors to view defects in various bodily structures that may not be readily apparent from a two-dimensional image. Similarly, structures within moles and lesions on the skin may be characterized by analyzing static medical images. Images of certain manufactures, such as airplane rotor blades, may be analyzed to detect structural defects that are invisible to the naked eye due to their size or their location within a surrounding structure. This application is especially useful to detect, for example, internal corrosion of screws or rivets that hold components together using X-rays, without the necessity to disassemble the components and visually inspect the fasteners. Defects in plastic injection moldings (such as “short shots” and short molds” as those terms are used in the art) may be identified by comparing the scattering patterns of an ideal mold to a target mold for irregularities or anomalies in the target mold as a result of uneven thickness of the plastic scattering medium. Tornadoes may be detected from aerial or satellite images based on the different absorption or scattering characteristics between tornadic air and the surrounding air. Similarly, volcanic plumes may be analyzed to separate out smoke from ash from rocks, lava, and other ejecta based on particle size. Images of forest fires may be analyzed to recognize advancing lines of flames through smoke. And hidden weapons may be detected through clothing, based on scattering of energy having frequencies inside (or outside) the visible spectrum.

Other embodiments of the invention provide analysis of video having a stationary sensor. In these embodiments, multiple, time-sequenced images of the same scene are analyzed, thereby permitting computation of three-dimensional motion vectors and other depth characteristics. These computations permit object identification and tracking in 3D space. For example, a moving object may be identified by a collection of pixels whose 3D motion vectors are identical. This information, in turn, can be used to measure objects and predict their motion. In one such application, a standard video camera is converted into a “radar gun” using the video post-processing effects disclosed herein. Such post-processing effects may be implement as a software application for execution on a smartphone having an integrated camera, or other such device. Security cameras may intelligently monitor restricted areas for movement and for foreign objects (such as people) by monitoring changes in the depth map of the camera field of vision. Similarly, these depth calculation techniques may be used to predict movements of interesting people, and direct the cameras to track them automatically. Analysis of video with a stationary sensor may also be used to track movements of people playing video games using their bodies as the controller. Similarly, game cameras may track the 3D position and orientation of a hand-held controller, without the need to use an inertial measurement unit (IMU) in the controller itself. In yet another application, one may predict volcanic eruptions by analyzing a time series of images of off-gassing (especially in non-visible wavelengths scattered by the typical gasses emitted). Or, usefully, one may predict or plot the path of dust of plumes of erupting volcanoes based on differential scattering, without requiring aircraft to enter the plumes. In forestry and agriculture applications, one may measure growth by analyzing a time series of images for differences in scattering caused by the growth of flora, and more particularly the increasing thicknesses of leaves, trunks, and other growing parts. Other applications may be seen by a person having ordinary skill in the art.

The techniques described herein may also be applied to analysis of video having a moving sensor. One application includes, for example, using real-time depth information to remove “camera shake” in the production of movies, both in the home video and professional markets. Real-time depth information may be invaluable in the medical robotic surgery field, in which a surgeon controls a moving apparatus on which is mounted a camera whose image is displayed in an operating room. Real-time depth information of the images taken by the camera, when correlated with 3D information relating to a patient's anatomy (perhaps also obtained in real-time using these techniques), can assist the surgeon to accurately guide the instrument through the body. These techniques may also be applied to simultaneous location and mapping (SLAM) uses, such as determining the location of a person in a closed or shielded area, such as a building or tunnel. In such environments, GPS tracking is unavailable, and a tracking solution using multiple IMUs may be expensive to implement.

Further applications include the real-time conversion of two-dimensional images and video into three-dimensional images and data. One use of the disclosed techniques for calculating depth in this field is the inexpensive post-processing of cameras that produce two-dimensional image and video signals to easily provide three-dimensional data, without the need to purchase expensive new hardware. A hardware or software post-processing module may be coupled with cameras capturing, for example, news or sports events, so that these cameras now transmit 3D video. Or, such post-processing modules may be incorporated into consumer televisions, thereby providing the capability to optionally convert any incoming 2D television signal into a 3D signal for display. In another embodiment, certain 2D medical images like X-ray images, CAT scans, MRI scans, PET scans, and ultrasound scans may be converted into 3D data for further diagnostic benefits. In particular, due to the rapid nature of the estimation of the transmission vectors t(x,y), ultrasound scans may be converted into 3D data in real-time, thereby permitting development of 3D ultrasound machines using existing ultrasound technology. Post-processing may also be used in the automotive environment, to permit existing cameras installed on cars to obtain real-time distance information to nearby objects, such as other cars.

In other embodiments, a movie, recorded as 2D video, may be converted into 3D video in real-time, without the need for specialized 3D camera equipment. A depth map may be calculated for each successive frame of video, and the depth maps can then be used to output successive frames of 3D video. Using a head-mounted infrared camera at night, another embodiment creates a 3D virtual reality model for display using, for example, electronic goggles. This embodiment may be combined with 3D location data to provide location awareness. In still another embodiment, 3D models of items shown in photographs may be reconstructed. This embodiment is particularly useful with old photographs, or photographs of objects that are no longer being manufactured, to obtain data about imaged people or objects respecting which it may be impossible to take new images. Extracting depth information from several photographs using these techniques permits rapid, accurate construction of 3D models for use in wide-ranging applications. For example, video game “levels” may be rapidly prototyped, and video games may generate highly realistic 3D background images from just a few camera images, without the need for stereoscopic photography or complicated and processor-intensive rendering processes. As another example, law enforcement may create a 3D model of a suspect's head, which may be used as an alternate form of identification, or may use these depth data to compare a mug shot to an image taken from a field camera. Panoramic camera data may be mapped to cylindrical or spherical coordinates to permit construction of a virtual reality environment permitting, for example, virtual tours of real estate.

Any of these uses may be improved using other data or automatic sensor adjustments, in some cases in combination with haze removal. For example, once haze is removed from an image of an atmospheric scene, depth information may be obtained about objects previously obscured by the haze. The revealing of certain obscured objects may suggest the use of a second spectral band to use in an iterative application of these techniques to further refine and sharpen the image. Moreover, other information, such as a pre-existing terrain map, may be used in combination with depth information obtained through the above method to calibrate an imaging system to permit it to more accurately remove haze, or allow the imaging system to more accurately determine its position in three dimensions. Other information, such as data produced by an IMU that is part of the imaging system, may be combined with the calculated depth information to assist in this process. Other applications of this real-time removal of scattering effects include sharpening images of subsurface geologic features, obtained for example using seismic data; and sharpening images of stellar phenomena that are partially obscured by dust clouds or other interstellar media.

FIGS. 2B and 2C provide alternative embodiments of FIGS. 2 and 2A respectively. FIG. 2B shows an embodiment of the invention that is computer implemented and that generates output image data based upon input image data. The input image data in this embodiment is obtained by imaging a physical object in a field of view through a medium. Although the term physical object is singular, one or ordinary skill in the art would appreciate that multiple physical objects may be present within the input image data. In a first computer process, an estimated transmission vector is determined based upon the input image data. 22B. The estimated transmission vector may be based upon the Koschmieder equation as previously suggested. Further, one or more assumptions may be made in order to determine the estimated transmission vector. For example, it may be assumed that scattering is due to particular spectral frequency band. As previously discussed, the blue color channel may be assumed to account substantially all of the scattering if the image was taken in natural sunlight. In other embodiments, wherein other media are present between the sensor and the object, other spectral frequency bands may contribute more significantly to scatter. For example, spectral frequency bands in the yellow spectrum may contribute to scatter if the media is smoke and spectral frequency bands the green spectrum may contribute to scatter if the media is water. Other spectral frequency bands may be used to determine attenuation information about an object. For example, spectral frequency bands that include red may be used to determine attenuation. In this embodiment, at least one component of the estimated transmission vector is substantially equal to at least one normalized spectral channel value of the digital input image data. Additionally, each spectral channel value comprises a contribution from at least one of attenuation in first spectral band and scattering in a second spectral band. In a second computer process, output image data is determined based upon the estimated transmission vector 24B. The output image data provides more information about the physical object while removing information due to the scattering effects of light.

FIG. 2C is an alternative embodiment for determining depth information from input image data. In a first computer process, an estimated transmission vector is determined 22C The components of the estimated transmission vector are substantially equal to at least one normalized spectral channel value for the digital input image data. It should be recognized that the normalized spectral channel may include multiple and discrete frequency bands. The normalized spectral channel value comprises contributions of at least one of attenuation in a first spectral band and scattering in a second spectral band. Thus, the normalized spectral channel value has possible values between 0.0 and 1.0 wherein a first frequency band may contribute to scattering and a second frequency band may contribute to attenuation of light resulting from the physical object. In certain applications and embodiments, the normalized spectral channel value may include contribution from both attenuation and scattering for a component of the estimated transmission vector. Once the estimated transmission vector is determined, a second computer process determines depth values associated with addressable locations of the digital data within the digital input image using the digital input image data and the estimated transmission vector. 24C. As expressed above, the estimated transmission vector, the depth information and the output image data may be used for a multitude of different applications.

With reference to FIG. 3, a method is now described for determining a value representing ambient energy, such as atmospheric light, in the image data (the unknown variable “A” in the Koschmieder equation). The method of FIG. 3 identifies a particular, representative pixel in the image data, and uses the intensity of the representative pixel (or a value from one or more of the color channels of the representative pixel) as the value of A.

To begin the method, the image processing system may subsample the image data in process 31. By subsampling the data, the process of calculation is accelerated, as fewer steps are required. The subsampling frequency can be selected according to the particular needs of a specific application. By subsampling at a greater frequency, i.e., including more data in the calculation, processing speed is sacrificed for a possible improvement in accuracy. By subsampling at a lower frequency, i.e., including less data in the calculation, processing speed is improved, but accuracy may be sacrificed. One embodiment that subsamples every sixteenth pixel of every sixteenth row has been found to provide acceptable accuracy and speed. Thus, in a first row every sixteenth pixel will be considered in the calculation. None of the pixels in any of rows two through sixteen is included in the calculation. Then in the seventeenth row (row 1+16=17), every sixteenth pixel is considered. The subsampling process continues for the thirty-third row (17+16=33), and so on through an entire image. Subsampling frequencies may be selected to be powers of two, such as eight, sixteen, thirty-two, etc., as use of powers of two may be more efficient in certain programming implementations of the image processing. Other subsampling frequencies may be used as well, according to the needs of a particular implementation, as will be understood by one of ordinary skill in the art.

The data set of subsampled pixels is then processed to determine a minimum value of the color channels for the subsampled pixels in process 32. For example, for a pixel having red, green, and blue (RGB) color channels, the values of each of these three color channels are compared to determine a minimum value. For example, if a first pixel has RGB values of R=130, G=0, B=200, the minimum value for that pixel is 0. If a second pixel has RGB values of R=50, G=50, B=50, the minimum value for that pixel is 50.

The image processing system then will determine a selected pixel having the greatest minimum value in process 33. For our first and second exemplary pixels just mentioned, the minimum value for the first pixel is 0, and the minimum value for the second pixel is 50, so the second pixel has the greatest minimum value. Accordingly, if these were the only pixels being considered, the second pixel would be the selected pixel.

The image processing system then determines a value of A based on the selected pixel in process 34. According to some embodiments, the image processing system calculates an intensity value for the selected pixel using the values of the color channels for the selected pixel. It is known in the art to calculate an intensity value of a pixel by, for example, calculating a linear combination of the values of the red, green, and blue color channels. The calculated intensity can then be used as a value of A. In accordance with the convention that A should fall in a range between 0 and 1, the value of A may be normalized to represent a percentage of maximum intensity.

The process just described for determining a value of A is further demonstrated in the following pseudocode:

```
for y = 0 to height−1 (stepping by samplesize, e.g., 16)
  for x = 0 to width−1 (stepping by samplesize, e.g., 16)
  if min(inpixel(x,y).red,inpixel(x,y).green,inpixel(x,y).blue)>highestMin
    save inpixel, new highestMin
A = intensity of pixel with highestMin
```

In some embodiments where the image data is video data including a series of frames of image data, A may be recalculated for each successive image. Calculating A for each successive image provides the most accurate and up to date value of A at all times. In other embodiments, A may be calculated less frequently. In video image data, successive images often are very similar to each other in that much of the color data may be very close to the values of the frames of data that are close in time, representing similar lighting conditions. Accordingly, a value of A that was calculated for one frame of data could be used for several succeeding frames as well, after which a new value of A may be calculated. In certain situations where the atmospheric light of a scene is relatively constant, A may not even need to be recalculated at all after the first time.

An alternative process for determining a value of A is now described with reference to FIG. 3A. The pixels in the image data are organized into a series of blocks of pixels. For example, the blocks may be 15 pixels wide by 15 pixels high. Image data describing a 150 pixel by 150 pixel image would then contain 100 blocks of pixels. The image is 10 blocks wide (15×10=150), and 10 blocks high (10×10=100). Alternately, a block of pixels of arbitrary size is designated to be a region of interest to a viewer. In this case, the below algorithm is applied with respect to only the pixels in the region of interest.

In each block, the pixels are processed to determine the pixel having the minimum intensity in that block in process 31A. In our example above, 100 pixels will be identified, one from each block. For each block, the intensity of each pixel is calculated, and the pixel in the block having the smallest intensity is selected. Once the minimum-intensity pixels are determined for each block of pixels, the image processing system determines the block having the greatest intensity for its minimum-intensity pixel in process 32A. If, for example, the highest intensity of the 100 selected pixels is the pixel selected from block 25, then block 25 has the greatest minimum-intensity. The image processing system then determines a value of A based on the selected pixel in the selected block in process 33A. In our example, the pixel that was selected as having the minimum intensity in block 25, which was a greater intensity than any other minimum intensity pixel from any other block. The intensity of this selected pixel may then be used as a value of A. In accordance with the convention that A should fall in a range between 0 and 1, the value of A may be normalized to represent a percentage of maximum intensity.

The process just described for determining a value of A is further demonstrated in the following pseudocode:

```
for block = 0 to number of blocks
  for x = 0 to blockwidth
    for y = 0 to blockheight
    if intensity of pixel(x,y) < minIntensity
    save pixel(x,y), new minIntensity
if minIntensity of current block > maxMinIntensity
save current block, new maxMinIntensity
A = intensity minIntensity of block with maxMinIntensity
```

The two procedures for determining a value of A described above are merely exemplary. Other procedures may be followed as well, according to the specific requirements of an embodiment of the invention. A value of A may be estimated from a most haze-opaque pixel. This may be, for example, a pixel having the highest intensity of any pixel in the image. The procedure of FIG. 3A includes determining a minimum intensity pixel in each of a plurality of blocks of pixels, and determining the highest intensity of the minimum pixels. This procedure also could be modified to include determining a minimum color channel value in the minimum intensity pixel in each of the blocks, and determining the highest value of the minimum color channel values. The procedure could be further modified to include selecting several of the pixels having the highest values of the minimum color channel values, and not just the one highest value. Then intensity values may be compared for these pixels, and the pixel having the highest intensity may be selected. Other variations and modifications in addition to the procedures given here will be apparent to one of ordinary skill in the art.

In some alternative embodiments, two values of A are used. The first value is used to solve the Koschmieder equation once an estimated transmission vector has been calculated. In one embodiment, the first value of A is determined to be the maximum intensity of any pixel in the image. In a second embodiment, this first value is the maximum intensity among pixels in a subsample. In a third embodiment, the first value of A is the maximum intensity of pixels in a region of interest.

The second value of A is used to estimate the transmission vector t(x,y). This second value is calculated as a root-mean-square (RMS) of the intensities of several representative pixels. In various embodiments, the representative pixels comprise the entire image, a subsample of the image, or a region of interest, as above.

The use of two different values for the ambient energy provides improved results for a number of reasons. The computations used to determine these two values of A are simpler than those of FIGS. 3 and 3A, and may be performed in a single pass over all relevant pixels. These two values of A are not scalars but vectors, and may have different values in each color channel. This is important, because different color channels may reflect frequencies having different absorption or scattering characteristics in the given medium. And the use of RMS intensity values rather than absolute intensity values better reflects the physics relating to combining the intensities of a number of color channels into a single pixel intensity.

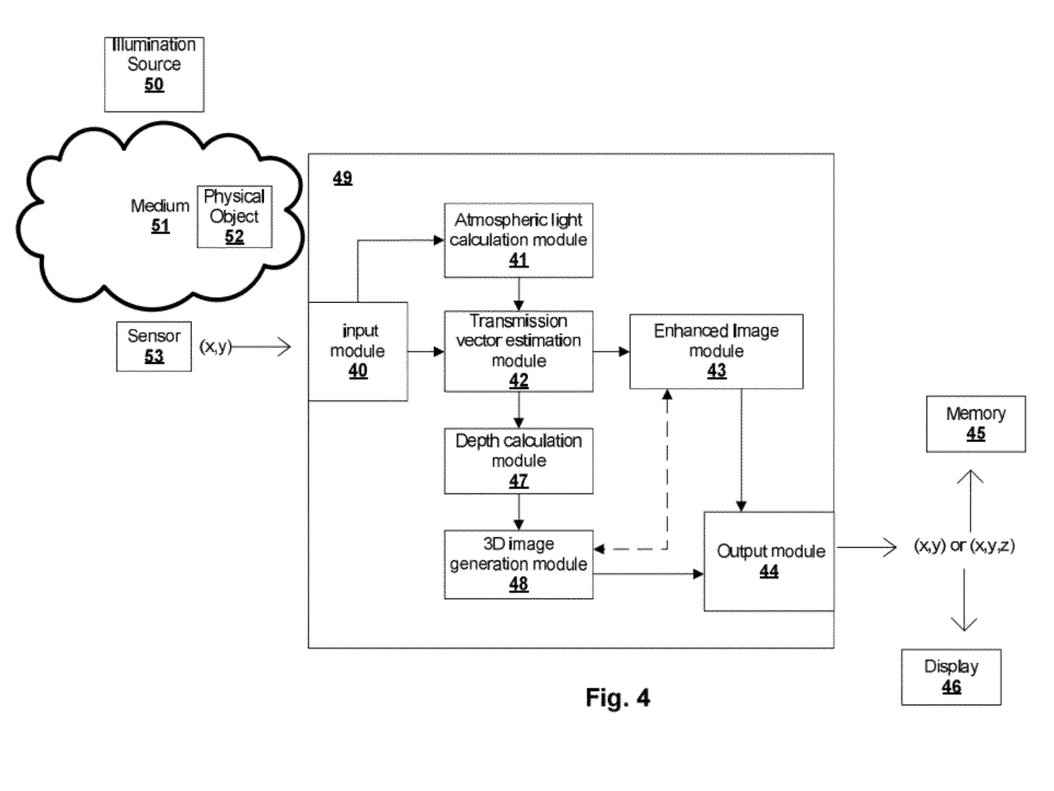

An image processing system in accordance with an embodiment of the present invention is now described with reference to FIG. 4. The image processing system presented in FIG. 4 includes modules for facilitating both the creation of three dimensional image data from two dimensional image data as well as enhanced image data (e.g. haze, smoke, fog reduction etc.) from a two dimensional input image. It should be recognized by one of ordinary skill in the art that all of the modules presented in FIG. 4 need not be present and may be optional depending on the purpose of the image processing system. The image processing system 49 receives digital input image data in an image input module 40. The digital input image data are representative of a physical object 52 imaged through a medium 51 by a sensor 53, as described above, and contain a plurality of pixels having associated (x, y) coordinates. The image processing system 49 passes the image data received from the sensor 53 from the input module 40 to an ambient energy calculation module 41 and to a transmission vector estimation module 42. The ambient energy calculation module 41 processes the image data to generate a value of A according to one of the methods described above, and delivers the value of A to the transmission estimation module 42. The transmission estimation module 42 determines an estimated transmission vector for the digital input image data based at least upon one contiguous spectral band of the digital image input data. The determination may be made using a value of ambient energy determined as described above in connection with FIG. 3 or 3A.

The transmission estimation module 42 then delivers the input image data, the value of A, and the estimated transmission vector to at least one of an image enhancement module 43 and/or to a depth calculation module 47. When the image enhancement module 43 receives data, it enhances the image data as described above with respect to FIG. 2, and provides the resulting enhanced image data to an image output module 44. When the depth calculation module receives 47 data, it generates a depth map, as described above with respect to FIG. 2A, and provides the depth map and image data to a 3D image generation module 48. The 3D image generation module 48 processes the depth map and image data to generate 3D image data, which is passed to the image output module 44. In some cases the image processing system 49 may generate image data that is both enhanced and converted to 3D by passing the output of the image enhancement module 43 to the 3D image generation module 48 or vice versa, after which the enhanced 3D image data is generated and passed to the image output module 44. The image output module 44 then outputs the output image data, which may be 2D data or 3D data, based on whether 3D image generation was performed. As previously mentioned, not all of the modules are required in the image processing system. For example, if only enhanced images are desired, the depth calculation module 47 and the 3D image generation module 48 need not be present in such an embodiment.

The output image data may be sent to memory 45 for storage. The memory 45 may be RAM or other volatile memory in a computer, or may be a hard drive, tape backup, CD-ROM, DVD-ROM, or other appropriate electronic storage. The output image data also may be sent to a display 46 for viewing. The display 46 may be a monitor, television screen, projector, or the like, or also may be a photographic printing device and the like for creating durable physical images. The display 46 also may be a stereoscope or other appropriate display device such as a holographic generator for viewing 3D image data. Alternatively, 3D image data may be sent to a 3D printer, e.g. for standalone free-form fabrication of a physical model of the image data.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) in a tangible storage medium, such as a semiconductor memory device (e.g., a RAM, ROM, PROM, EEPROM, or Flash-Programmable memory), a magnetic memory device (e.g., a diskette or fixed disk), an optical memory device (e.g., a CD-ROM), a PC card (e.g., PCMCIA card), or other memory device. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or temporarily in a tangible storage medium, such as a semiconductor memory device (e.g., a RAM, ROM, PROM, EEPROM, or Flash-Programmable memory), a magnetic memory device (e.g., a diskette or fixed disk), an optical memory device (e.g., a CD-ROM), or other memory device. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The embodiments of the invention described above are intended to be merely exemplary; numerous variations and modifications will be apparent to those skilled in the art. All such variations and modifications are intended to be within the scope of the present invention as defined in any appended claims.

### Alternative Embodiments of the Present Invention

Additional embodiments of the present invention are listed hereinafter, without limitation. The embodiments provided for below are described as computer-implemented method claims. However, one of ordinary skill in the art would realize that the method steps may be embodied as computer code and the computer code could be placed on a non-transitory computer readable medium defining a computer program product.

1. A computer-implemented method for generating at least one depth value from digital input image data, the digital input image data representative of a physical object imaged through a medium, the computer-implemented method comprising:
in a first computer-implemented process, determining an estimated transmission vector for the medium, wherein the estimated transmission vector is based upon one contiguous spectral band of the digital input image data; and in a second computer-implemented process determining the depth value from the digital input image data based upon the estimated transmission vector.

2. A computer-implemented method according to claim 1, wherein the at least one depth value corresponds to a depth map for the digital input image data.

3. A computer-implemented method according to claim 1 wherein determining the estimated transmission vector is based upon at least a second contiguous spectral band.

4. A computer-implemented method according to claim 3 wherein the contiguous spectral bands are selected based upon a pre-determined criterion.

5 A computer-implemented method according to claim 3 wherein the contiguous spectral band is selected based upon a pre-determined criterion.

6 A computer-implemented method according to claim 4 wherein the pre-determined criterion is based upon spectral characteristics of the medium.

7 A computer-implemented method according to claim 4 wherein the pre-determined criterion is based upon spectral characteristics of the physical object.

8. A computer-implemented method according to claim 4 wherein the pre-determined criterion is based upon distance.

9. A computer-implemented method according to claim 4, wherein the pre-determined criterion optimizes distance resolution.

10. A computer-implemented method according to claim 1, wherein the one contiguous spectral band is a visible spectral band.

11. A computer-implemented method according to claim 1, wherein components of the transmission vector are derived from the digital input image data in the contiguous spectral band based on scattering properties of the medium.

12. A computer-implemented method according to claim 11 wherein the scattering properties are due to Mie-scattering.

13. A computer-implemented method according to claim 11 wherein the scattering properties are due to Raman-scattering.

14. A computer-implemented method according to claim 11 wherein the scattering properties are due to Rayleigh scattering.

15. A computer-implemented method according to claim 11 wherein the scattering properties are due to Compton scattering.

16. A computer-implemented method according to claim 1, wherein estimating a transmission vector further includes:
compensating at least one component of the estimated transmission vector based upon a known spectral characteristic of the medium.

17. A computer-implemented method according to claim 1, wherein the one contiguous spectral band is chosen based upon the medium.

18. A computer-implemented method according to claim 1 further comprising:
compensating at least one component of the estimated transmission vector based upon a known spectral characteristic of the physical object.

19. A computer-implemented method according to claim 1 further comprising:
compensating at least one component of the estimated transmission vector based upon a second contiguous spectral band of the digital image input data.

20. A computer-implemented method according to claim 1, wherein the contiguous spectral band may be weighted.

21. A computer-implemented method according to claim 1, wherein the one contiguous spectral band corresponds to red color data in the digital input image data.

22. A computer-implemented method according to claim 1, wherein the one contiguous spectral band corresponds to yellow color data derived from the digital input image data.

23. A computer-implemented method according to claim 1, wherein the one contiguous spectral band corresponds to green color data from the digital input image data.

24. A computer-implemented method according to claim 1, wherein the one contiguous spectral band is defined according to a specified color encoding.

25. A computer-implemented method according to claim 1 wherein the digital input image data is a result of natural illumination.

26. A computer-implemented method according to claim 1 wherein the digital input image data is a result of tailored illumination.

27. A computer-implemented method according to claim 26 wherein the tailored illumination is that of a non-thermal emitter.

28. A computer-implemented method according to claim 27, wherein the one contiguous spectral band is determined based upon spectral characteristics of the non-thermal emitter in order to reduce scattering.

29. A computer-implemented method according to claim 1 wherein the one contiguous spectral band of the digital image input data determines scattering information for the estimated transmission vector and wherein determining the estimated transmission vector further includes determining attenuation information for the estimated transmission vector based upon a second contiguous spectral band of the digital input image data.

30. A computer-implemented method according to claim 1, wherein determining an estimated transmission vector further requires that the estimated transmission vector is also based upon a second contiguous spectral band and the physical object is imaged through a second medium.

31. A computer-implemented method according to claim 1, wherein the one contiguous spectral band is a visible spectral band.

32. A computer-implemented method according to claim 1, wherein determining the depth value comprises:

d(x,y)=−β*ln(t(x,y))
wherein d(x,y) is a depth value for a pixel at coordinates (x,y), β is a scatter factor, and t(x,y) is the transmission vector.

33. A computer-implemented method of generating digital output image data from digital input image data, the digital input image data representative of a physical object imaged through a medium, the computer-implemented method comprising:
in a first computer-implemented process, determining an estimated transmission vector for the medium, wherein the estimated transmission vector is based upon one contiguous spectral band of the digital image input data; and
in a second computer-implemented process, calculating the digital output image based in part upon the estimated transmission vector.

34. A computer-implemented method according to claim 33 wherein the medium intervenes at least between the physical object and an imaging sensor, wherein the imaging sensor produces an output that results in the digital input image data.

35. A computer-implemented method according to claim 33 wherein the one contiguous spectral band of the digital image input data determines scattering information for the estimated transmission vector and wherein determining the estimated transmission vector further includes determining attenuation information for the estimated transmission vector based upon a second contiguous spectral band of the digital input image data.

36. A computer-implemented method according to claim 33, wherein determining an estimated transmission vector further requires that the estimated transmission vector is also based upon a second contiguous spectral band and the physical object is imaged through a second medium.

37. A computer-implemented method according to claim 33, wherein the one contiguous spectral band is a visible spectral band.

38. A computer-implemented method according to claim 33, wherein components of the transmission vector are derived from the digital input image data in the contiguous spectral band based on scattering properties of the medium.

39. A computer-implemented method according to claim 38 wherein the scattering properties are due to Mie-scattering.

40. A computer-implemented method according to claim 38 wherein the scattering properties are due to Raman-scattering.

41. A computer-implemented method according to claim 38 wherein the scattering properties are due to Rayleigh scattering.

42. A computer-implemented method according to claim 38 wherein the scattering properties are due to Compton scattering.

43. A computer-implemented method according to claim 33, wherein estimating a transmission vector further includes:
compensating at least one component of the estimated transmission vector based upon a known spectral characteristic of the medium.

44. A computer-implemented method according to claim 33, wherein the one contiguous spectral band is chosen based upon the medium.

45. A computer-implemented method according to claim 33 further comprising:
compensating at least one component of the estimated transmission vector based upon a known spectral characteristic of the physical object.

46. A computer-implemented method according to claim 33 further comprising:
compensating at least one component of the estimated transmission vector based upon a second contiguous spectral band of the digital image input data.

47. A computer-implemented method according to claim 33, wherein the contiguous spectral band may be weighted.

48. A computer-implemented method according to claim 33 wherein the one contiguous spectral band corresponds to red color data in the digital input image data.

49. A computer-implemented method according to claim 33 wherein the one contiguous spectral band corresponds to yellow color data derived from the digital input image data.

50. A computer-implemented method according to claim 33 wherein the one contiguous spectral band corresponds to green color data from the digital input image data.

51. A computer-implemented method according to claim 33 wherein the one contiguous spectral band is defined according to a specified color encoding.

52. A computer-implemented method according to claim 33, further comprising determining a value for scattered ambient light in the input image data and wherein calculating the digital output image is further based upon the value for scattered ambient light in the input image data.

53. A computer-implemented method according to claim 52, wherein the digital input image data comprises a plurality of color channels each having a value associated with each position within the image and the value for scattered ambient light is determined by finding the maximum value of the minimum values for all of the color channels.

54. A computer-implemented method according to claim 33, further comprising determining a vector for scattered ambient light in the digital input image data and calculating the digital output image is further based upon the vector for scattered ambient light in the digital input image data and wherein the digital input image data comprises a plurality of color channels each having an intensity value associated with each position within the image and the vector for the scattered ambient light in the digital input image is determined by using a maximum intensity value of an image area of interest from each color channel of the digital input image data for each vector component for scattered ambient light and dividing each vector component for scattered ambient light by a root mean squared value for all of the digital input image data within the image area of interest.

55. A computer-implemented method according to claim 54, wherein the area of interest includes a sub-section of the digital input image data.

56. A computer-implemented method according to claim 55, wherein the area of interest includes all of the digital input image data.

57. A computer-implemented method according to claim 33, wherein calculating the output image comprises solving the equation:

I(x,y)=J(x,y)*t(x,y)+A*(1−t(x,y))
to determine a value of J, where I is a color vector of the input image derived from the input image data, J is a color vector that represents light from objects in the input image, t is the estimated transmission vector, and A is a constant that represents ambient light scattered in the input image data.

58. A computer-implemented method according to claim 22, wherein solving the equation further comprises:

determining a value for A based upon the digital input image data.

59. A computer-implemented method according to claim 33 wherein the digital input image data is a result of natural illumination.

60. A computer-implemented method according to claim 33 wherein the digital input image data is a result of tailored illumination.

61. A computer-implemented method according to claim 33 wherein the contiguous spectral band is selected based upon a pre-determined criterion.

62. A computer-implemented method according to claim 26 wherein the pre-determined criterion is based upon spectral characteristics of the medium.

63. A computer-implemented method according to claim 27 wherein the pre-determined criterion is based upon spectral characteristics of the physical object.

What is claimed is:

1. A computer-implemented method of generating depth data based on digital input image data, the digital input image data representative of a physical object in a field of view imaged through a medium, the digital input image data associated with a spectral channel, the method comprising:
in a first computer-implemented process, determining an estimated transmission vector for the medium; and
in a second computer-implemented process, deriving the depth data based on the estimated transmission vector wherein:
components of the estimated transmission vector are substantially equal to at least one normalized spectral channel value for the digital input image data, and each spectral channel value comprises contributions of at least one of attenuation in a first spectral band and scattering in a second spectral band.

2. A computer-implemented method according to claim 1, wherein components of the estimated transmission vector vary with spectral characteristics of distinct spectral bands.

3. A computer-implemented method according to claim 1 wherein the spectral bands are selected based upon a pre-determined criterion.

4. A computer-implemented method according to claim 3 wherein the pre-determined criterion is based upon spectral characteristics of the medium.

5. A computer-implemented method according to claim 3 wherein the pre-determined criterion is based upon spectral characteristics of the physical object.

6. A computer-implemented method according to claim 3 wherein the pre-determined criterion is based upon distance.

7. A computer-implemented method according to claim 3, wherein the pre-determined criterion optimizes distance resolution.

8. A computer-implemented method according to claim 1, wherein the spectral channel comprises a visible spectral band.

9. A computer-implemented method according to claim 1, wherein the spectral channel comprises at least one of an ultraviolet or an infrared band.

10. A computer-implemented method according to claim 1 wherein the scattering comprises due to Mie-scattering.

11. A computer-implemented method according to claim 1 wherein the scattering comprises Raman-scattering.

12. A computer-implemented method according to claim 1 wherein the scattering comprises Rayleigh scattering.

13. A computer-implemented method according to claim 1 wherein the scattering comprises Compton scattering.

14. A computer-implemented method according to claim 1, wherein estimating a transmission vector further includes:
compensating at least one component of the estimated transmission vector based upon a known spectral characteristic of the medium.

15. A computer-implemented method according to claim 1, wherein the one spectral band is chosen based upon a known spectral characteristic of the medium.

16. A computer-implemented method according to claim 1 further comprising:
compensating at least one component of the estimated transmission vector based upon a known spectral characteristic of the physical object.

17. A computer-implemented method according to claim 1, wherein at least one of the spectral bands is weighted.

18. A computer-implemented method according to claim 1 wherein one spectral band corresponds to one of blue, yellow, green and red color data from the digital input image data.

19. A computer-implemented method according to claim 1 wherein the digital input image data is a result of natural illumination.

20. A computer-implemented method according to claim 1 wherein the digital input image data is a result of tailored illumination.

21. A computer-implemented method according to claim 1 wherein the tailored illumination is that of a non-thermal emitter.

22. A computer-implemented method according to claim 21, wherein one of the spectral bands is determined based upon spectral characteristics of the non-thermal emitter in order to reduce scattering.

23. A computer-implemented method according to claim 1, wherein the spectral channel includes at least a visible spectral band.

24. A computer-implemented method according to claim 1, wherein determining the depth value comprises:
d(x,y)=−β*ln(t(x,y))
wherein d(x,y) is the depth value for a pixel at coordinates (x,y), β is a scatter factor, and t(x,y) is the estimated transmission vector.

25. A computer-implemented method according to claim 1 wherein the medium intervenes at least between the physical object and an imaging sensor, wherein the imaging sensor produces an output that results in the digital input image data.

26. A computer-implemented method according to claim 1, further comprising:
determining a value for scattered ambient light in the input image data wherein calculating the estimated transmission vector is further based upon the value for scattered ambient light in the input image data.

27. A computer-implemented method according to claim 26, wherein the digital input image data comprises a plurality of color channels each having an intensity value associated with each position within the image and the value for scattered ambient light is determined by finding the maximum of the minimum values for all of the color channels.

28. A computer-implemented method according to claim 1, further comprising: determining a vector for scattered ambient light in the digital input image data wherein calculating the estimated transmission vector is further based upon the vector for scattered ambient light in the digital input image data.

29. A computer-implemented method according to claim 1, wherein the spectral channel is selected to maximize a range of values of the transmission vector in the field of view.

30. A computer-implemented method of generating output digital image data based on digital input image data, the digital input image data representative of a physical object in a field of view imaged through a medium, the method comprising:
in a first computer-implemented process, determining an estimated transmission vector for the medium; and
in a second computer-implemented process, deriving the output digital image data based on the estimated transmission vector wherein:
at least one component of the estimated transmission vector is substantially equal to at least one normalized spectral channel value of the digital input image data, and each spectral channel value comprises contributions of at least one of attenuation in a first spectral band and scattering in a second spectral band.

31. A computer-implemented method according to claim 1, wherein components of the estimated transmission vector vary with spectral characteristics of distinct spectral bands.

32. A computer-implemented method according to claim 30, wherein the spectral channel is selected to maximize a range of values of the transmission vector in the field of view.

33. A computer-implemented method according to claim 30 wherein the spectral bands are selected based upon a predetermined criterion.

34. A computer-implemented method according to claim 33 wherein the pre-determined criterion is based upon spectral characteristics of the medium.

35. A computer-implemented method according to claim 33 wherein the predetermined criterion is based upon spectral characteristics of the physical object.

36. A computer-implemented method according to claim 33 wherein the predetermined criterion is based upon distance.

37. A computer-implemented method according to claim 33 wherein the predetermined criterion optimizes distance resolution.

38. A computer-implemented method according to claim 30, wherein the spectral channel comprises a visible spectral band.

39. A computer-implemented method according to claim 30, wherein the spectral channel comprises at least one of ultraviolet or an infrared band.

40. A computer-implemented method according to claim 30, wherein estimating a transmission vector further includes:
compensating at least one component of the estimated transmission vector based upon a known spectral characteristic of the medium.

41. A computer-implemented method according to claim 30, wherein the spectral bands are chosen based upon the medium.

42. A computer-implemented method according to claim 30 further comprising:
compensating at least one component of the estimated transmission vector based upon a known spectral characteristic of the physical object.

43. A computer-implemented method according to claim 30, wherein at least one of the spectral bands is weighted.

44. A computer-implemented method according to claim 30 wherein one of the spectral bands corresponds to one of blue, yellow, green, and red color data in the digital input image data.

45. A computer-implemented method according to claim 30 wherein the spectral channel is defined according to a specified color encoding.

46. A computer-implemented method according to claim 30, further comprising:
determining a value for scattered ambient light in the input image data wherein calculating the estimated transmission vector is further based upon the value for scattered ambient light in the input image data.

47. A computer-implemented method according to claim 46, wherein the digital input image data comprises a plurality of color channels each having an intensity value associated with each position within the image and the value for scattered ambient light is determined by finding the maximum of the minimum values for all of the color channels.

48. A computer-implemented method according to claim 30, further comprising: determining a vector for scattered ambient light in the digital input image data wherein calculating the estimated transmission vector is further based upon the vector for scattered ambient light in the digital input image data.

49. A computer-implemented method according to claim 30, wherein calculating the output image comprises solving the equation:
I(x,y)=J(x,y)*t(x,y)+A*(1−t(x,y))
to determine a value of J, where I is a color vector of the input image derived from the input image data, J is a color vector that represents light from objects in the input image, t is the estimated transmission vector, and A is a constant that represents ambient light scattered in the input image data.

50. A computer-implemented method according to claim 49, wherein solving the equation further comprises:
determining a value for A based upon the digital input image data.

51. A computer-implemented method according to claim 30 wherein the digital input image data is a result of natural illumination.

52. A computer-implemented method according to claim 30 wherein the digital input image data is a result of tailored illumination.

53. A computer program product including a non-transitory computer-readable medium having computer code thereon for generating depth data based on digital input image data, the digital input image data representative of a physical object in a field of view imaged through a medium, the digital input image data associated with a spectral channel, the computer code comprising:
computer code for determining an estimated transmission vector for the medium; and
computer code for deriving the depth data based on the estimated transmission vector wherein:
components of the estimated transmission vector are substantially equal to at least one normalized spectral channel value for the digital input image data, and each spectral channel value comprises contributions of at least one of attenuation in a first spectral band and scattering in a second spectral band.

54. A computer-implemented method according to claim 53, wherein components of the estimated transmission vector vary with spectral characteristics of distinct spectral bands.

55. A computer program product according to claim 53, wherein the spectral channel is selected to maximize a range of values of the transmission vector in the field of view.

56. A computer program product according to claim 53 wherein the spectral bands are selected based upon a pre-determined criterion.

57. A computer program product according to claim 56 wherein the pre-determined criterion is based upon spectral characteristics of the medium.

58. A computer program product according to claim 56 wherein the pre-determined criterion is based upon spectral characteristics of the physical object.

59. A computer program product according to claim 56 wherein the pre-determined criterion is based upon distance.

60. A computer program product according to claim 56, wherein the pre-determined criterion optimizes distance resolution.

61. A computer program product according to claim 53, wherein the spectral channel comprises a visible spectral band.

62. A computer program product according to claim 53, wherein the spectral channel comprises at least one of an ultraviolet or an infrared band.

63. A computer program product according to claim 53 wherein the scattering comprises due to Mie-scattering.

64. A computer program product according to claim 53 wherein the scattering comprises Raman-scattering.

65. A computer program product according to claim 53 wherein the scattering comprises Rayleigh scattering.

66. A computer program product according to claim 53 wherein the scattering comprises Compton scattering.

67. A computer program product according to claim 53, wherein estimating a transmission vector further includes:
computer code for compensating at least one component of the estimated transmission vector based upon a known spectral characteristic of the medium.

68. A computer program product according to claim 53, wherein the one spectral band is chosen based upon a known spectral characteristic of the medium.

69. A computer program product according to claim 53 further comprising:
computer code for compensating at least one component of the estimated transmission vector based upon a known spectral characteristic of the physical object.

70. A computer program product according to claim 53, wherein at least one of the spectral bands is weighted.

71. A computer program product according to claim 53 wherein one spectral band corresponds to one of blue, yellow, green and red color data from the digital input image data.

72. A computer program product according to claim 53 wherein the digital input image data is a result of natural illumination.

73. A computer program product according to claim 53 wherein the digital input image data is a result of tailored illumination.

74. A computer program product according to claim 53 wherein the tailored illumination is that of a non-thermal emitter.

75. A computer program product according to claim 74, wherein one of the spectral bands is determined based upon spectral characteristics of the non-thermal emitter in order to reduce scattering.

76. A computer program product according to claim 53, wherein the spectral channel includes at least a visible spectral band.

77. A computer program product according to claim 53, wherein determining the depth value comprises:
d(x,y)=−β*ln(t(x,y))
wherein d(x,y) is the depth value for a pixel at coordinates (x,y), β is a scatter factor, and t(x,y) is the estimated transmission vector.

78. A computer program product according to claim 53 wherein the medium intervenes at least between the physical object and an imaging sensor, wherein the imaging sensor produces an output that results in the digital input image data.

79. A computer program product according to claim 53, further comprising:
computer code for determining a value for scattered ambient light in the input image data wherein calculating the estimated transmission vector is further based upon the value for scattered ambient light in the input image data.

80. A computer program product according to claim 79, wherein the digital input image data comprises a plurality of color channels each having an intensity value associated with each position within the image and the value for scattered ambient light is determined by finding the maximum of the minimum values for all of the color channels.

81. A computer program product according to claim 53, further comprising:
computer code for determining a vector for scattered ambient light in the digital input image data wherein calculating the estimated transmission vector is further based upon the vector for scattered ambient light in the digital input image data.

82. A computer program product including a non-transitory computer-readable medium having computer code thereon for generating digital output image data based on digital input image data, the digital input image data representative of a physical object in a field of view imaged through a medium, the digital input image data associated with a spectral channel, the computer code comprising:
computer code for determining an estimated transmission vector for the medium; and
computer code for deriving the output digital image data based on the estimated transmission vector wherein:
at least one component of the estimated transmission vector is substantially equal to at least one normalized spectral channel value of the digital input image data, and each spectral channel value comprises contributions of at least one of attenuation in a first spectral band and scattering in a second spectral band.

83. A computer program product according to claim 82, wherein components of the estimated transmission vector vary with spectral characteristics of distinct spectral bands.

84. A computer program product according to claim 82, wherein the spectral channel is selected to maximize a range of values of the transmission vector in the field of view.

85. A computer program product according to claim 82 wherein the spectral bands are selected based upon a predetermined criterion.

86. A computer program product according to claim 85 wherein the pre-determined criterion is based upon spectral characteristics of the medium.

87. A computer program product according to claim 85 wherein the predetermined criterion is based upon spectral characteristics of the physical object.

88. A computer program product according to claim 85 wherein the predetermined criterion is based upon distance.

89. A computer program product according to claim 85 wherein the predetermined criterion optimizes distance resolution.

90. A computer program product according to claim 82, wherein the spectral channel comprises a visible spectral band.

91. A computer program product according to claim 82, wherein the spectral channel comprises at least one of ultraviolet or an infrared band.

92. A computer program product according to claim 82, wherein estimating a transmission vector further includes:
compensating at least one component of the estimated transmission vector based upon a known spectral characteristic of the medium.

93. A computer program product according to claim 82, wherein the spectral bands are chosen based upon the medium.

94. A computer program product according to claim 82 further comprising:
compensating at least one component of the estimated transmission vector based upon a known spectral characteristic of the physical object.

95. A computer program product according to claim 82, wherein at least one of the spectral bands is weighted.

96. A computer program product according to claim 82 wherein one of the spectral bands corresponds to one of blue, yellow, green, and red color data in the digital input image data.

97. A computer program product according to claim 82 wherein the spectral channel is defined according to a specified color encoding.

98. A computer program product according to claim 82, further comprising:
determining a value for scattered ambient light in the input image data wherein calculating the estimated transmission vector is further based upon the value for scattered ambient light in the input image data.

99. A computer program product according to claim 98, wherein the digital input image data comprises a plurality of color channels each having an intensity value associated with each position within the image and the value for scattered ambient light is determined by finding the maximum of the minimum values for all of the color channels.

100. A computer program product according to claim 82, further comprising: determining a vector for scattered ambient light in the digital input image data wherein calculating the estimated transmission vector is further based upon the vector for scattered ambient light in the digital input image data.

101. A computer program product according to claim 82, wherein calculating the output image comprises solving the equation:
I(x,y)=J(x,y)*t(x,y)+A*(1−t(x,y))
to determine a value of J, where I is a color vector of the input image derived from the input image data, J is a color vector that represents light from objects in the input image, t is the estimated transmission vector, and A is a constant that represents ambient light scattered in the input image data.

102. A computer program product according to claim 101, wherein solving the equation further comprises:
determining a value for A based upon the digital input image data.

103. A computer program product according to claim 82 wherein the digital input image data is a result of natural illumination.

104. A computer program product according to claim 82 wherein the digital input image data is a result of tailored illumination.

105. An image processing system, comprising:
an input module that receives digital input image data for a physical object imaged through a medium;
an atmospheric light calculation module that receives the digital input image data from the input module and calculates atmospheric light information;
a transmission vector estimation module that receives the digital input image data from the input module, and estimates a transmission vector for the medium based on a spectral band of the digital input image data and the atmospheric light information; and
an enhanced image module that receives digital input image data and the transmission vector and generates output image data.

106. The image processing system according to claim 105 wherein the image processing system includes:
an illumination source for illuminating the physical object through the medium; and
a sensor for receiving energy representative of the physical object through the medium and converting the energy into digital input image data.

107. An image processing system according to claim 105 further comprising:
an output module that receives the output image data and outputs the output image data to at least one of a digital storage device and a display.

108. An image processing system, comprising:
an input module that receives digital input image data containing color information for an imaged physical object imaged through a medium;
an atmospheric light calculation module that receives the digital input image data from the input module and calculates atmospheric light information;
a transmission vector estimation module that receives the digital input image data from the input module, and estimates a transmission vector for the medium based on a spectral band of the digital input image data and the atmospheric light information; and
a depth calculation module that receives digital input image data and the transmission vector and generates a depth map.

109. An image processing system according to claim 108 further comprising:
a three-dimensional image generation module that receives the digital input image data and the depth map and generates three-dimensional output image data using the digital input image data and the depth map.

110. An image processing system according to claim 109 further comprising:
an output module that receives the three-dimensional output image data and outputs the three-dimensional output image data to at least one of a digital storage device and a display.

111. The image processing system according to claim 107 wherein the image processing system includes:
an illumination source for illuminating the physical object through the medium; and
a sensor for receiving energy representative of the physical object through the medium and converting the energy into digital input image data.
